(19) United States
(12) Patent Application Publication
(10) Pub. No.: US 2026/0216660 A1
(43) Pub. Date: Jul. 30, 2026

(54) CHEMICALLY ENHANCED ELECTRODIALYSIS (CEED): A UNIVERSAL PLATFORM FOR SELECTIVE ION REMOVAL

(71) Applicant: Texas Tech University System, Lubbock, TX (US)

(72) Inventors: Kristin HUTCHINS, Lubbock, TX (US); Weile YAN, Lexington, MA (US); Michael FINDLATER, Merced, CA (US)

(73) Assignee: TEXAS TECH UNIVERSITY SYSTEM, Lubbock, TX (US)

(21) Appl. No.: 19/148,443

(22) PCT Filed: Jan. 17, 2024
(86) PCT No.: PCT/US2024/011720

§ 371 Date: Jul. 16, 2025

Related U.S. Application Data
(60) Provisional application No. 63/439,510, filed on Jan. 17, 2023.

(51) Int. Cl. B01D 69/02; B01D 61/46; B01D 67/00; B01D 69/12; B01J 47/016; C22B 3/42; C22B 59/00

(52) U.S. Cl. CPC B01D 69/02; B01D 61/461; B01D 61/463; B01D 67/00931; B01D 67/00933; B01D 69/1214; B01J 47/016; C22B 3/42; C22B 59/00; B01D 2313/345; B01D 2325/42

(57) ABSTRACT

A method for recovering target metal ions from a fluid stream using a chemically enhanced electrodialysis membrane, the method including selecting a cation-exchange membrane comprising a surface, synthesizing an ion sequestrant, wherein the ion sequestrant is capable of binding the target metal ions, grafting the ion sequestrant onto the cation-exchange membrane, wherein the grafting results in a thin layer of the ion sequestrant being affixed to the surface of the cation-exchange membrane, placing the cation-exchange membrane in an electrodialysis unit, wherein the electrodialysis unit comprises an anode, a cathode, and a diluate chamber, passing a diluate stream through the diluate chamber, wherein the diluate stream comprises the target metal ions, passing the diluate stream through the thin layer of the ion sequestrant affixed to the surface of the cation-exchange membrane, and binding the target metal ions to the cathode-exchange membrane.

### CROSS-REFERENCE TO RELATED PATENT APPLICATION

This application claims priority to U.S. Provisional Application Ser. No. 63/439,510, filed Jan. 17, 2023, entitled “Chemically Enhanced Electrodialysis (Ceed): A Universal Platform For Selective Ion Removal”.

### STATEMENT OF FEDERALLY FUNDED RESEARCH

The present disclosure is related to federally funded research and development under Contract No. CBET-1701512 awarded by the NSF covering “EAGER: GOALI: Crown Ether-enhanced Electrodialysis for Selective Removal of Problematic Ions in Feed Water and Waste Fluid of Unconventional Energy Production.” The government has certain rights in this invention.

The present disclosure is related to federally funded research and development under Contract No. DE-SC0020204 awarded by the Department of Energy covering “Chemically Enhanced Electrodialysis (CEED) for Recovery of Rare Earth Elements.” The government has certain rights in this invention.

### TECHNICAL FIELD

The present disclosure relates to an improved electrodialysis apparatus, system, and method using Chemically Enhanced Electrodialysis (“CEED”). In particular, the present disclosure relates to treatments of water and wastewater and the use of electrodialysis for such water and wastewater treatment. The present disclosure additionally relates to the markets for geothermal drilling, geothermal production, oil and gas drilling, and produced water treatment, as the disclosed CEED relates to treatments applicable in each of the aforementioned contexts.

Moreover, the present disclosure relates to Rare Earth Elements (“REEs”), which are naturally occurring elements that may be found in the environment. Specifically, the present disclosure relates to mining, refining, and recycling such REEs. The present disclosure relates to recovering REEs based on the use of an improved electrodialysis apparatus, system, and method using CEED.

### BACKGROUND

The removal of metal ions from an aqueous medium has long posed a problem when scientists have attempted a targeted removal of specific metal ions. For example, an aqueous solution may include both metal ions that are sought to be enriched and problematic metal ions that need to be removed from the solution. Without targeted removal of these ions, the process of removing metal ions may result in large energy consumption.

Nonetheless, these energy expensive processes are often used in industrial applications of non-conventional water resources, since the use of such non-conventional water resources require extraction of low-level undesirable ions from matrices of benign dominant ions.

Currently, removal or concentration of ions can be achieved using conventional methods including ion-exchange, pressure-driven membrane separation such as reverse osmosis, and conventional electrodialysis.

It is therefore an objective of the present disclosure to increase the selectivity of the target metal ions in an electrodialysis process. The targeting in this disclosure can occur by grafting a thin layer of macromolecular complexing agents with high binding specificity for the target metals onto commercial cation exchange membranes. The resultant membranes can be used in an electrodialysis device, which can achieve more selective transport of the target metals compared to conventional electrodialysis using unmodified cation exchange membranes.

Moreover, targeted separation, removal, and reuse of rare-earth elements is a significant challenge within separation science. This is especially challenging in the context of REEs, which as the name suggests are naturally found in very low concentrations in the environment.

Current means of extracting REEs from mediums present a “pH-swing” mechanism, leading to the consumption of both acid and base throughout the process and generating large quantities of secondary waste products. The management of waste in a responsible fashion is costly and renders rare-earth separation economically unfeasible in those countries that have strict environmental legislation.

Additionally, mines containing REEs are often in countries where environmental and social standards are very low, leading to human rights violations, deforestation, and contamination of land and water. Near mining and industrial sites, the concentrations of REEs can rise to many times the normal background levels.

Once in the environment, REEs can leach into the soil, where their transport is determined by numerous factors including but not limited to erosion, weathering, pH, precipitation, groundwater, or combinations thereof. Acting much like metals, REEs can speciate depending on the soil condition, being either mobile or adsorbed to soil particles. Depending on their bio-availability, REEs can be absorbed into plants and later consumed by humans and animals. The mining of REEs, the use of REE-enriched fertilizers, and the production of phosphorus fertilizers all contribute to REE contamination. Furthermore, strong acids are used during the extraction process of REEs, which can then leach out into the environment and be transported through water bodies and resulting in the acidification of aquatic environments.

Moreover, mining, refining, and recycling of rare-earth metals have serious environmental consequences if not properly managed. Low-level radioactive tailings resulting from the occurrence of thorium and uranium in rare-earth element ores present a potential hazard, and improper handling of these substances can result in extensive environmental damage. In fact, billions of dollars in worldwide clean-up costs have been spent trying to manage REEs.

Currently, solvent extraction methods are being utilized in an attempt to extract and recover any REEs that flow out with the wastewater from mining facilities. However, such extraction and recovery equipment may not always be present on the outlets carrying the wastewater and can be energy expensive.

It is, accordingly and as mentioned, an objective of the present disclosure to separate REEs while avoiding the generation of secondary waste through the consumption of large amounts of acid and base. As a result, in some embodiments of the present disclosure, the process can enrich metal ions of interest or remove problematic metal ions selectively over background electrolytes, which allows for a supply chain source and would help mitigate some of the pollution at the extraction point.

In some embodiments, this present disclosure has the objective of recycling and reusing REEs that are already in use or reaching the end of their life cycle. In certain embodiments, the present disclosure can recover REEs from industrial waste with practical potential to reduce environmental and health impacts from mining, waste generation, and imports.

### SUMMARY OF THE INVENTION

The present invention is directed to a method and system for selectively removing or concentrating metal ions using CEED. In some embodiments, the targeted metal ions that are selectively removed or concentrated can be of interest for recycling/reuse efforts. From this, certain embodiments of the present invention are directed to a method and system for removing or concentrating REEs of interest in solutions or waste streams.

In general, in one embodiment, the disclosure features a method for recovering target metal ions from a fluid stream using a CEED membrane. The method includes selecting a cation-exchange membrane comprising a surface. The cation-exchange membrane carries a fixed charge. The cation-exchange membrane permits the permeation of cations. The cation-exchange membrane obstructs the passage of anions. The method further includes synthesizing an ion sequestrant. The ion sequestrant is capable of binding the target metal ions. The method further includes grafting the ion sequestrant onto the cation-exchange membrane. The grafting results in a thin layer of the ion sequestrant being affixed to the surface of the cation-exchange membrane. The thin layer of the ion sequestrant is continuous. The thin layer being affixed to the surface creates an ion-gating mechanism. The method further includes placing the cation-exchange membrane in an electrodialysis unit. The electrodialysis unit comprises an anode, a cathode, and one or multiple pairs of diluate and concentrate chambers. The method further includes passing a diluate stream through the diluate chamber. The diluate stream includes the target metal ions. The method further includes, as a result of passing the diluate stream through the diluate chamber, passing the diluate stream through the thin layer of the ion sequestrant affixed to the surface of the cation-exchange membrane. The method further includes, as a result of passing the diluate stream through the thin layer of the ion sequestrant, binding the target metal ions to the cathode-exchange membrane.

Implementations of the invention can include one or more of the following features:

The ion sequestrant can be selected from the group including crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

The synthesis of ion sequestrant can further include heating the ion sequestrant.

The synthesis of ion sequestrant can further include stirring the ion sequestrant.

The method can further include, prior to grafting the ion sequestrant onto the cation-exchange membrane, extracting an aqueous solution from the ion sequestrant.

The anode can include platinum-iridium metal oxide.

The cathode can include stainless steel.

The method can further include, after binding the target metal ions to the cathode-exchange membrane, removing the cathode-exchange membrane from the electrodialysis unit.

The method can further include, recovering the target metal ions from the cathode-exchange membrane.

The target metal ions can include a rare earth element.

The rare earth element can include one or more of neodymium, dysprosium, cerium, lanthanum, or combinations thereof.

In general, in another embodiment, the invention features a system for using a chemically enhanced electrodialysis membrane. The system includes an electrodialysis unit comprising an anode, a cathode, a diluate chamber, and a concentrate chamber. The diluate chamber is configured to receive a diluate stream. The system also includes a chemically modified cation-exchange membrane including a surface and a thin layer of an ion sequestrant affixed to the surface. The chemically modified cation-exchange membrane carries a fixed charge. The chemically modified cation-exchange membrane permits the permeation of cations. The chemically modified cation-exchange membrane obstructs the passage of anions. The ion sequestrant is configured to bind one or more target metal ions. The system also includes the diluate stream comprising the target metal ions. The diluate stream is configured to flow in a direction approaching the diluate chamber and the thin layer on the surface of the chemically modified cation-exchange membrane.

Implementations of the invention can include one or more of the following features:

The ion sequestrant can be selected from the group including crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

The target metal ions can include a rare earth element.

The rare earth element can include one or more of neodymium, dysprosium, cerium, lanthanum, or combinations thereof.

The anode can include platinum-iridium metal oxide.

In general, in another embodiment, the invention features a chemically enhanced electrodialysis membrane including a cation-exchange membrane. The chemically enhanced electrodialysis membrane also includes a surface. The cation-exchange membrane carries a fixed charge, permits the permeation of cations, and obstructs the passage of anions. The chemically enhanced electrodialysis membrane also includes a thin layer of an ion sequestrant affixed to the surface of the cation-exchange membrane. The ion sequestrant is configured to bind one or more target metal ions.

Implementations of the invention can include one or more of the following features:

The ion sequestrant can be selected from the group including crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

The target metal ions can include a rare earth element.

The rare earth element can include one or more of neodymium, dysprosium, cerium, lanthanum, or combinations thereof.

### BRIEF DESCRIPTION OF THE DRAWINGS

Other advantages of the present invention will be apparent from the following detailed description of the invention in conjunction with embodiments as illustrated in the accompanying drawings, in which:

FIG. 1 depicts a CEED membrane including physisorbed modified crown ether, in accordance with certain embodiments of the present disclosure.

FIG. 2A depicts a chart presenting the effects of diluate flow rate through a comparison between conventional methods using electrodialysis and the use of a CEED system, in accordance with certain embodiments of the present disclosure.

FIG. 2B depicts a chart presenting the effects of stack current density through a comparison between conventional methods using electrodialysis and the use of a CEED system, in accordance with certain embodiments of the present disclosure.

FIG. 3 depicts molecular structures of targeted ion sequestrants, in accordance with certain embodiments of the present disclosure.

FIG. 4 depicts a scheme showing a synthetic approach of developing substituted crown ethers, in accordance with certain embodiments of the present disclosure.

FIG. 5 depicts a scheme showing a synthetic approach of developing derivatives of calix[4]arenes, in accordance with certain embodiments of the present disclosure.

FIG. 6 depicts synthesis of vinyl-substituted benzo-crown ethers, in accordance with certain embodiments of the present disclosure.

FIG. 7 depicts the synthesis of “boot-strap” p-tert-butylcalix[4]arene-crown-6-dicarboxylic acid, in accordance with certain embodiments of the present disclosure.

FIG. 8 depicts a process for preparing crown-ether appended polymeric systems, in accordance with certain embodiments of the present disclosure.

FIG. 9 depicts a strategy for synthesizing lanthanide sequestrant-functionalized copolymers, in accordance with certain embodiments of the present disclosure.

FIG. 10 depicts the synthesis of crosslinker monomers and chemical structures, in accordance with certain embodiments of the present disclosure.

FIGS. 11A, 11B, and 11C respectively depict a schematic illustration of electrodialysis processes, in accordance with certain embodiments of the present disclosure. FIG. 11A is a conventional cation-exchange membrane, FIG. 11B is a cation-exchange membrane with crown-ethers embedded in the cation-exchange membrane matrix, and FIG. 11C is a cation-exchange membrane with a surface overlayer of polymerized crown ethers creating an ion-gating functionality.

FIG. 12 depicts a schematic setup of an electrodialysis unit to evaluate the performance of chemically-enhanced cation-exchange membranes, in accordance with certain embodiments of the present disclosure.

FIGS. 13A, 13B, and 13C depict the results of the working example in respect to concentration data, in accordance with certain embodiments of the present disclosure.

FIGS. 14A and 14B depict the effect of current density on the selectivity of Ba²⁺ over Na⁻ and Mg²⁺ over Na⁺ during electrodialysis, in accordance with certain embodiments of the present disclosure.

FIGS. 15A and 15B depict the effect of sodium cation concentration as a result of the process, in accordance with certain embodiments of the present disclosure.

FIG. 16 depicts the results from the working experiment showing a comparison of ion selectivity of membranes deposited with tBCalix4 and tBCalix4-C6DA, in accordance with certain embodiments of the present disclosure.

FIGS. 17A, 17B, and 17C depict a conceptual model of increased barium and magnesium selectivity through surface modification with sequestrants, in accordance with certain embodiments of the present disclosure.

### DETAILED DESCRIPTION OF THE INVENTION

The present invention relates to a system for chemically enhanced electrodialysis (“CEED”) to selectively target metal ions to remove or concentrate the metal ions and further, the method for using CEED to recover rare earth elements (“REEs”).

In certain embodiments, the CEED system utilizes a strong acid cation-exchange membrane. In such embodiments, the strong acid cation-exchange membrane is modified through surface deposition of a thin layer of macrocyclic molecules. The macrocyclic molecules, including the crown ether vinylbenzo-18-crown-6 (VB18C6) and the p-tert-Butylcalix[4]arene (tBCalix4), may be utilized to selectively extract/separate a barium cation (Barium (2+) or Ba²⁺) and a magnesium cation (Magnesium (2+) or Mg²⁺) from brackish water or brines that result from underground formations produced during energy operations. In some embodiments, the energy operations that produce the brackish water or brines are oil and gas or geothermal operations. In other embodiments, the CEED system can be used in industrial applications, such as wastewater treatment.

The CEED system can include a four-chamber electrodialysis unit. In some embodiments, the electrodialysis unit may include a platinum/iridium-mixed metal oxide-coated titanium anode and a stainless-steel cathode. For example, the stainless-steel cathode in some embodiment can be PCCell GmbH, ED model 64004. In some embodiments, the titanium anode and the stainless-steel cathode may be present at various current densities, such as 2.3, 3.1, 6.3 mA/cm2.

In some embodiments, using a cation-exchange membrane modified with the crown ether VB18C6 and the calixarene tBCalix4, the CEED system may present an increased selectivity for both Ba²⁺ and Mg²⁺ with respect to the dominant ion, such as sodium cation (Na⁺), in the feedwater by up to four times as compared to selectivity achieved with an unmodified cation-exchange membrane.

In an example CEED system, the cation-exchange membrane can be modified exclusively with calixarene tBCalix4. When modified with calixarene tBCalix4, the CEED system may achieve more efficient selectivity achieved at higher current densities. For example, the CEED system may operate at heightened efficiencies of selectivity in relation 3.1 mA/cm² and 6.3 mA/cm2 as opposed to 2.3 mA/cm2.

The CEED system may operate within or as a part of a platform for the recovery of REEs. In this platform, the CEED system may operate to remove or concentrate REEs of interest in brine solutions or aqueous waste streams. For example, the CEED system may isolate, for removal or concentration, the target ions that are of interest for recycling and reuse efforts. As a result, in some embodiments, the CEED system can reduce energy consumption compared to methods of extracting REEs that do not target specific metal ions.

To perform the solvent extraction, the CEED system can operate by grafting a thin layer of macromolecular complexing agents with high binding specificity for the target metals onto commercial cation exchange membranes. The resultant membranes can then be utilized in an electrodialysis device, which can achieve more selective transport of the target metals than conventional electrodialysis using unmodified cation exchange membranes.

In some embodiments, divalent ion extraction using CEED technology can be customized with respect to the applied electrodialysis cell's operating current density. By customizing based upon current density, the CEED system can allow for increased ion extraction.

Moreover, in some embodiments, the type and amount of crown ether or calixarene sequestrant agents used in membrane fabrication can be tailored to the specific type of divalent ion to be removed from a solution or brine, including but not limited to feedwater or wastewater.

The use of the CEED system, accordingly, can allow for cost efficiencies as compared to the dominant wastewater and brine treatment, which require osmotic pressure and energy expensive processes. Additionally, the CEED system may be scalable across various mediums holding REEs.

### Electrodialysis Apparatus

Non-conventional water sources may require ion separation technologies. The common practices to treat water for total dissolved solid include pressure-driven membrane separation, such as reverse osmosis, and thermally enabled separation processes, such as membrane distillation. As mentioned above, these conventional desalination technologies to remove low-concentration problematic ions from saline water matrices will incur an excessive energy input. Accordingly, in some embodiments, the present disclosure is capable of removing specific targeted ions without going through general desalination processes.

Compared to reverse osmosis and nanofiltration, electrodialysis is able to withstand a broader range of temperature and water chemistry and is more robust against fouling than pressure-driven membrane separation processes.

An electrodialysis apparatus includes a cation-exchange membrane and an anion-exchange membrane. The cation and anion-exchange membranes are capable of carrying fixed charges. The fixed charges can permit the permeation of ions of opposite charges, known as counter-ions. While the fixed charges permit the permeation of counter-ions, the fixed charges simultaneously obstruct the passage of similarly charged ions, known as co-ions.

### Chemically Enhanced Electrodialysis Apparatus

The CEED system, in preferred embodiments, includes ion-exchange membranes with tailored selectivity. To achieve tailored selectivity, in some embodiments, the surface of an ion-exchange membrane is amended with an oppositely charged layer to create monovalent ion-selective membranes.

In some embodiments, the CEED system incorporates crown ethers into a cation-exchange membrane to enable the selective removal of caesium (Cs⁺) relative to Na⁺. In such embodiments, to achieve this effect, the crown ethers can be confined in a thin layer on the membrane surface, enabling an ion-gating mechanism.

Accordingly, in some embodiments, the CEED system includes modified electrodialysis membranes with ion-gating properties, which are modified by incorporating appropriate ion sequestrants such as crown ethers or calixarene-crown ethers on the surface of conventional ion-exchange membranes. The modification in such an embodiment can allow the ion-exchange membranes to attain selective separation of target ions such as barium, strontium, or radium from saline matrices.

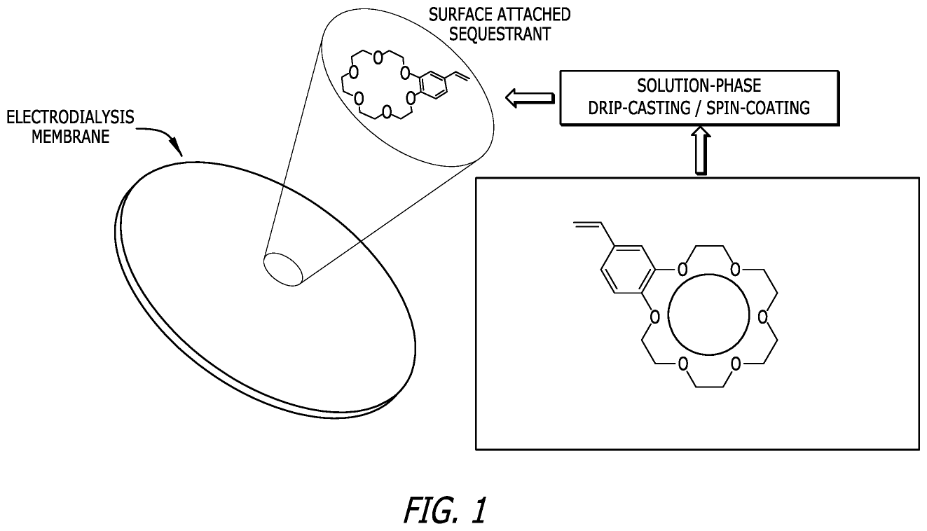

FIG. 1 depicts a CEED membrane including physisorbed modified crown ether according to some embodiments of the present disclosure. In FIG. 1, the electrodialysis membrane has been chemically enhanced through the incorporation of ion sequestrants attached to the surface.

In the embodiment displayed in FIG. 1, the selective molecular sequestrants with an electrochemical separation method can increase ion selectivity from conventional electrodialysis methods. Additionally, in the embodiment of FIG. 1, the CEED membrane may operate at a markedly higher throughput than sorption process due to facilitated transport in electric field.

In some embodiments, as shown in FIG. 1, the ion-specific sequestrants can be retained on the CEED membrane surface for continuous use.

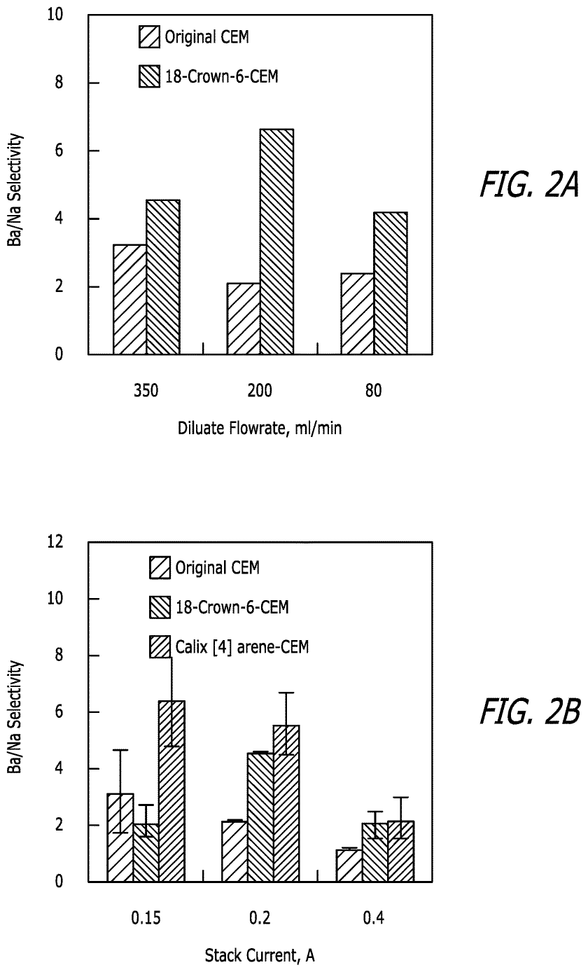

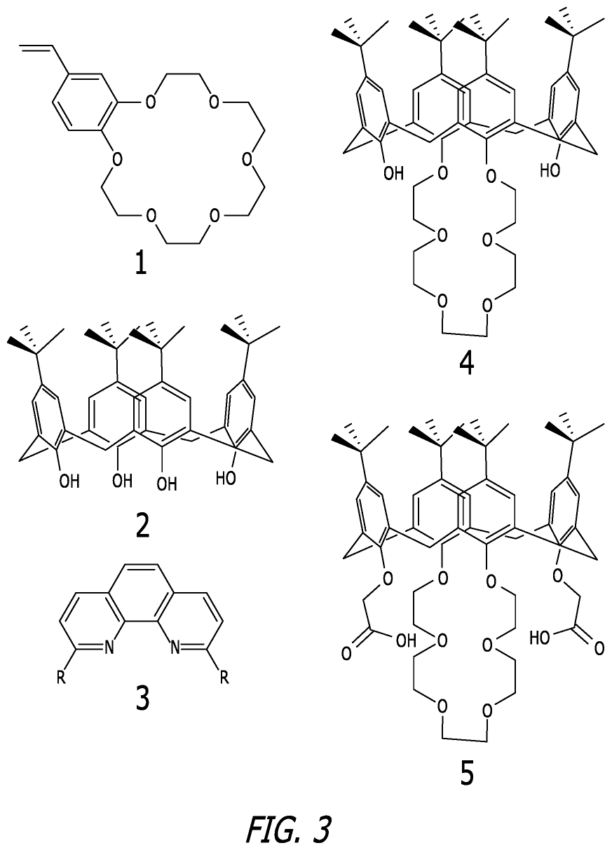

FIGS. 2A and 2B respectively depict two charts presenting comparison between conventional methods using electrodialysis and the use of CEED system. In the embodiment of FIGS. 2A and 2B, the feed composition was 0.1 M Na, 5*103 M Mg, and 1*10-3 M Ba.

In FIG. 2A, the chart shows the effects of diluate flow rate by displaying a chart of Ba²⁺/Na⁺ selectivity vs. diluate flowrate. As shown in FIG. 2A, for the same flowrates (350, 200, and 80 milliliters per minute), the CEED system displays improved ion selectivity rates of Ba²⁻ over Na⁺.

In FIG. 2B, the chart shows the effects of stack current by displaying a chart of Ba²/Na selectivity vs. stack current. As shown in FIG. 2B, for the same stack currents (0.15, 0.2, and 0.4 A), the CEED system displays improved ion selectivity rates of Ba²⁺ over Na⁺.

Moreover, as shown in FIGS. 2A and 2B, optimal selectivity can be attained with moderate current density and in mild flow field as opposed to high current density and high flowrate required by conventional ED to overcome mass transport limitation.

In some embodiments, the CEED system may allow for selective sequestration of rare earth elements by functionalizing conventional ion-exchange membranes with a thin layer of ion sequestrant and application of the modified membranes shown in FIG. 1 with the qualities reflected in FIGS. 2A and 2B.

Crown ethers are macrocyclic compounds containing oxygen as donor atoms. In some embodiments, because of the addition of crown ethers, the CEED system can exhibit selective sequestering properties towards metal ions that are controlled by the size and shape of the cavity relative to the metal cations of interest.

FIG. 1 illustrates salient features of a well-studied crown ether, 18-crown-6, which is known to exhibit high selectivity for K⁺ and Ba²⁺ ions. In such an embodiment, the selectivity stems in a large part from a close match between the ionic radii of Ba²⁺ (2.76 Å) and K⁺ (2.72 Å) and the cavity size of 18-crown-6 (2.6 Å).

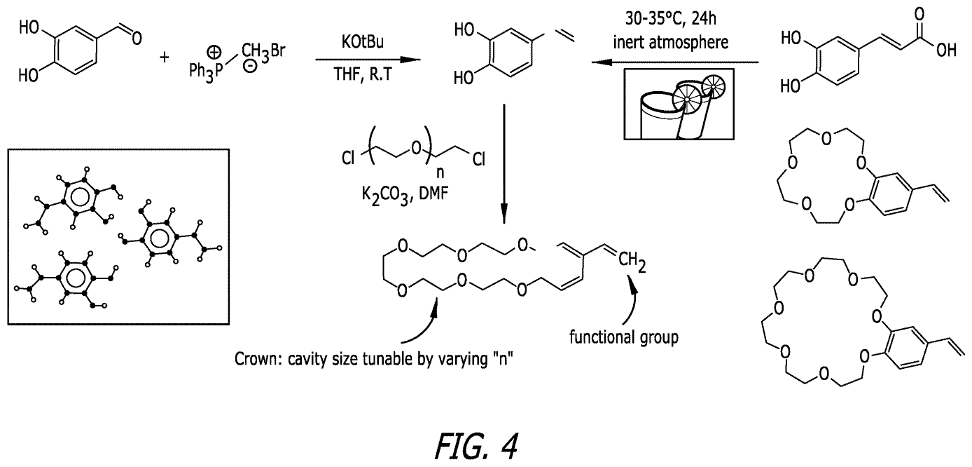

FIG. 3 depicts molecular structures of targeted ion sequestrants. For example, FIG. 3 (1) displays the structure of styryl-modified crown ether. As another example, FIG. 3 (2) displays t-Butyl calix[4]arene. As another example, FIG. 3 (3) displays phenanthroline. As another example, FIG. 3 (4) displays crown-ether “bootstrapped” t-Butylcalix[4]arene, As another example, FIG. 3 (5) displays ionizable crown-ether “boot-strapped” t-Butylcalix[4]arene.

In some embodiments, the ion-exchange membranes are modified with crown ethers, calixarene-decorated crown ethers, or combinations thereof. In certain embodiments, the methods of using the ion-exchange membranes may include modular synthesis of derivatized or ionizable crown ethers, N-donor based ligands such as phenanthroline, and identification of the most selective sequestrants for targeted lanthanide ions via binary extraction studies. Further, in some embodiments, the surface grafting methods can include covalently linking the sequestrants with electrodialysis membranes.

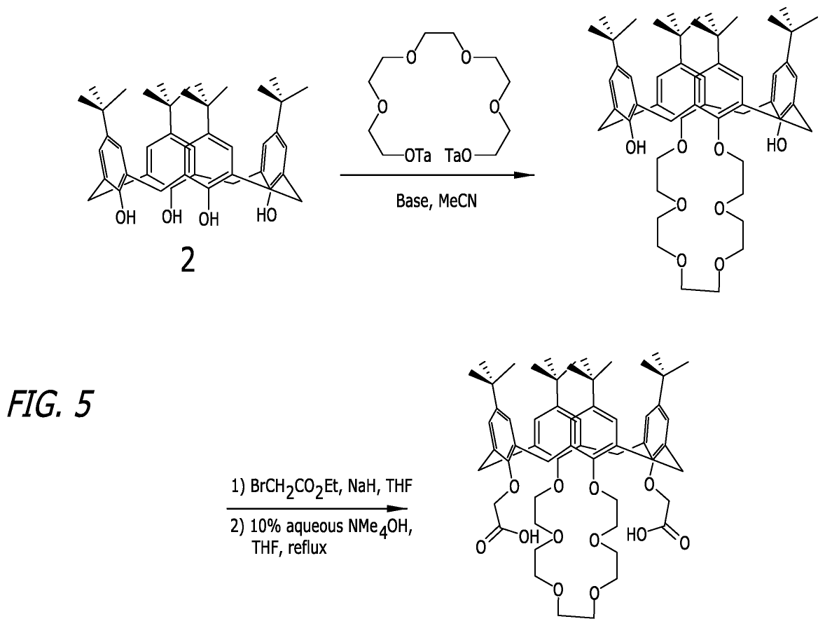

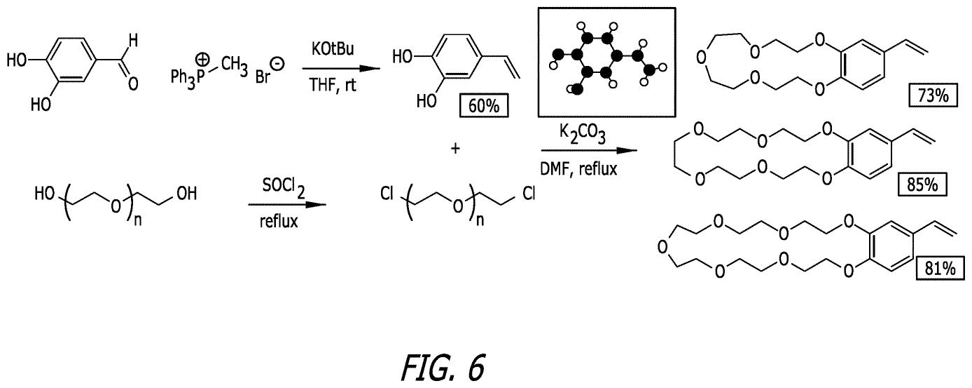

FIG. 4 depicts a scheme showing a synthetic approach of developing substituted crown ethers in accordance with certain embodiments of the present disclosure. As shown in FIG. 5, the modular nature of synthesis can allow variation of cavity size. Moreover, as shown in FIG. 5, the synthetic approach may include an appended polymerizable group for potential heterogenizing of sequestrant.

Methods of using the CEED system can include rapid diversification of crown ether structures through a modular synthetic plan. The example scheme depicted in FIG. 4 is designed to allow flexibility in the choice of crown ether sequestration agent. FIG. 4 shows the synthesis of 3,4-dihydroxystyrene and the conversion to the benzo-18-crown-6 analogue as an example of the synthetic strategy for use with the CEED system. By choosing a common precursor, 3,4-dihydroxystyrene, a library of crowns for testing and analysis can be developed for use with the CEED system. Additionally, in some methods, through simple variation of the length of the linker, the process can modulate the size of the crown ether cavity.

In certain embodiments of the processes for using and preparing the CEED system crown ethers may be screened for their binding selectivity with target ions. In some embodiments, crown ethers can be dissolved in dichloromethane (DCM), chloroform, or acetonitrile at close to their saturated solubility to approximately 10-100 mM.

FIG. 5 depicts a scheme showing a synthetic approach of developing derivatives of calix[4]arenes in accordance with certain embodiments of the present disclosure.

In contrast to the hard O-donor crown ethers, ligands with soft N-donor atoms such as 2,9-bis-triazinyl-1,10-phenanthroline can also result in highly efficient separation of actinides from lanthanides. Modified phenanthrolines have also found extensive utilization in the separation of REEs, specifically the lighter lanthanides from their heavier brethren.

Calixarenes are readily available macrocycles, which consist of phenolic units bridged by methylene carbons, form a bucket shape in three-dimensions and, are prepared in a straightforward manner. Moreover, the phenol groups are easily functionalized thus affording a wide degree of structural and chemical modularity. Importantly, calixarenes have also found application in lanthanide and actinide coordination and separation.

FIG. 5 accordingly shows the synthetic process for obtaining derivatives that can be used with the CEED system to recover REEs.

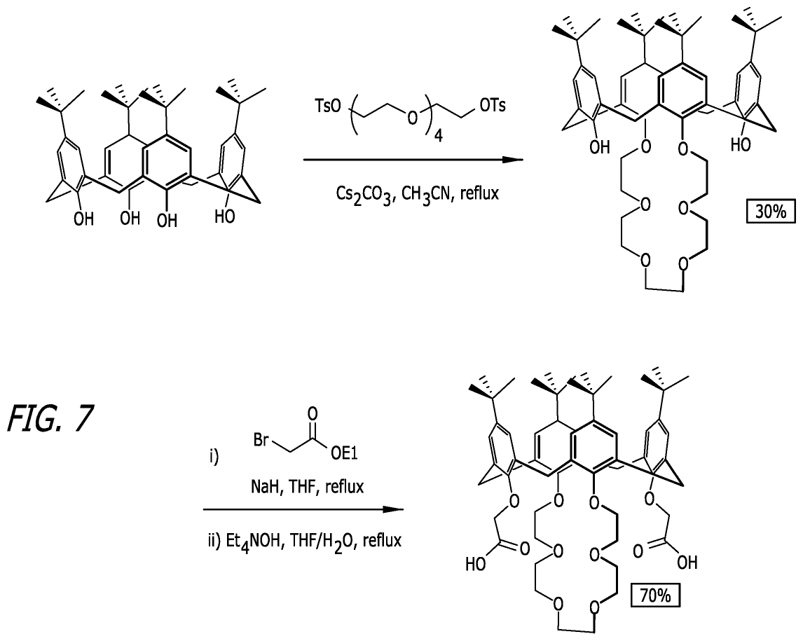

FIG. 6 depicts synthesis of vinyl-substituted benzo-crown ethers in accordance with certain embodiments of the present disclosure.

In certain embodiments, the preferential removal of specific ions derives from ion-binding abilities of the crown ether molecules. In such embodiments, the oxygen atoms in the central cavity are attracted to metal ions as depicted in FIG. 6. Further, in some embodiments, the size and conformation of the cavity determine binding specificity.

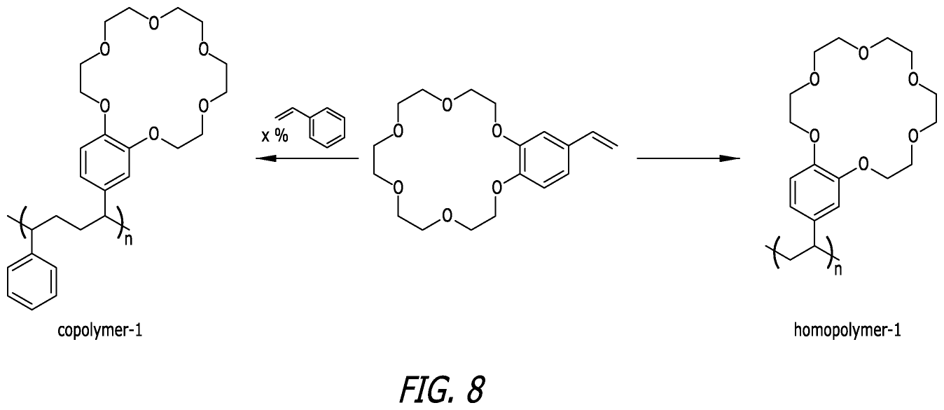

FIG. 7 depicts the synthesis of “boot-strapped” p-tert-butylcalix[4]arene-crown-6-dicarboxylic acid in accordance with certain embodiments of the present disclosure.

In addition to crown ethers, other macrocyclic ion sequestrants such as calixarenes can be used with the CEED system selectively extract various metal ions. The structure of calixarenes contains multiple phenolic units bridged by methylene groups, forming a three-dimensional bucket shape.

The most common calixarene compound is calix[4]arene, which contains four phenolic units. The phenol groups are easily functionalized with pendant ionizable groups, thus affording a large degree of structural and chemical modularity. Calixarenes have found applications in the extraction of barium and radium, heavy metals, and lanthanide and actinide separation. The selectivity of the ion sequestrants is controlled by metal-host conformational matching and chemical coordination.

In the embodiment depicted in FIG. 7, the chemical sequestrants can increase the membrane selectivity for dilute target ions amid the complex solution matrix. Since the structure and properties of the sequestrants are amendable to tuning for specific ions, coupling sequestrants with ion-exchange membranes may lead to a versatile and expandable approach for selective ion separation in lieu of the more energy-intensive general desalination treatment.

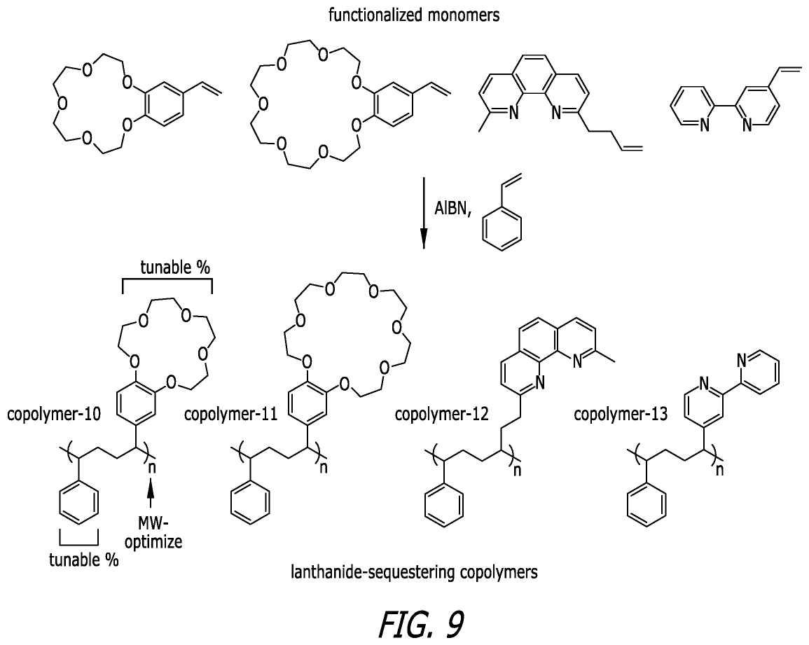

FIG. 8 depicts a process for preparing crown-ether appended polymeric systems in accordance with certain embodiments of the present disclosure.

In some embodiments, as depicted in FIG. 8, the process may include synthesizing macromolecules functionalized with ion-sequestrant motifs. Homopolymers of the crown ethers can be synthesized and will likely bind lanthanides. However, every crown ether motif comprising the homopolymer may not actually bind an ion. If two binding sites are close in proximity on the polymer chain, the positively charged lanthanides may not bind in neighboring sites due to charge repulsion.

The approach depicted in FIG. 8 involves synthesizing copolymers, wherein one monomer contains the lanthanide sequestrant motif and the second monomer is robust, inexpensive, and structurally compatible with the first.

In such a process, the copolymerization can be accomplished by radical chain-growth polymerization, and the copolymers can be isolated by precipitation and purified by re-precipitation.

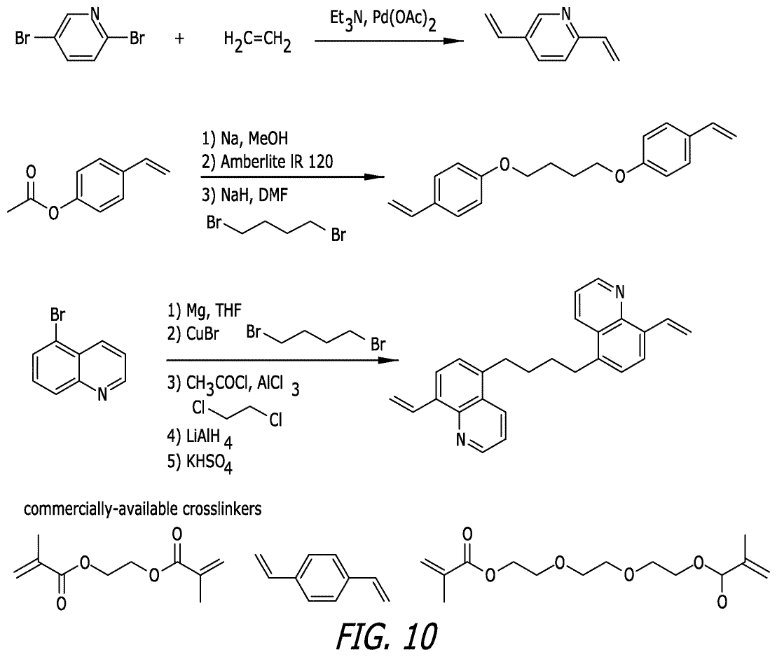

FIG. 9 depicts a strategy for synthesizing lanthanide sequestrant-functionalized copolymers in accordance with certain embodiments of the present disclosure.

The molecular weight of polymers often gives rise to different properties, such as film formation ability. Thus, in some embodiments, the process involves the synthesis of copolymers of varying molecular weight to determine the range at which superior film formation ability and high ion selectivity are achieved. Once synthesized, the copolymers can be fabricated into a thin film layer on the surface of the electrodialysis membrane.

In the strategy shown through FIG. 9, crosslinkers can also be incorporated into polymers to alter physical properties. A crosslinker can add structural robustness, porosity, or functionality to the polymer. To increase lanthanide binding efficiency, in some embodiments, the process can incorporate multi-functional crosslinkers into polymers, which impact robustness, swelling, and are capable of binding contaminants.

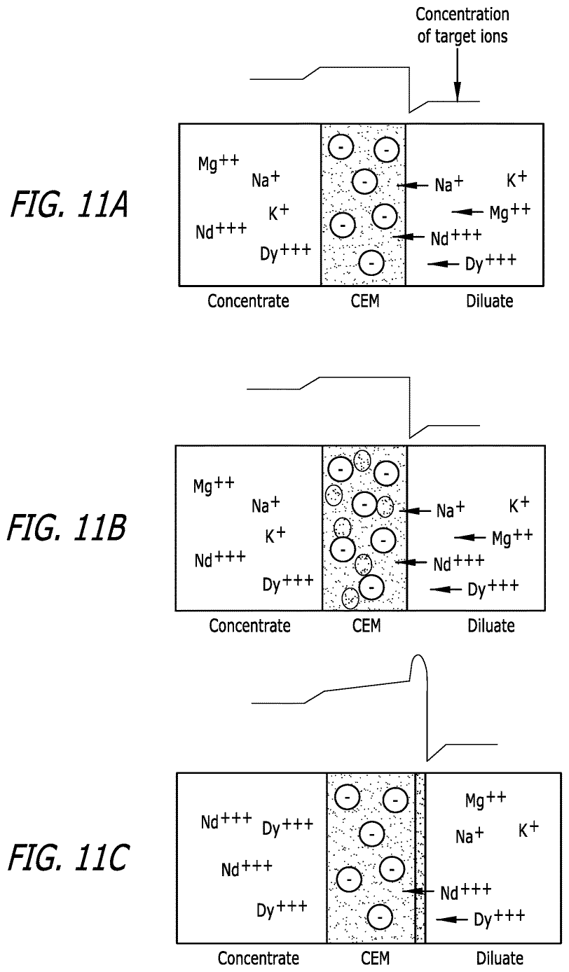

FIG. 10 depicts the synthesis of crosslinker monomers and chemical structures in accordance with certain embodiments of the present disclosure. In some embodiments, as depicted in FIG. 10, the lanthanide binding efficiency of the CEED process may be adjusted by the incorporation of crosslinkers into the polymers.

### Electrodialysis Processes

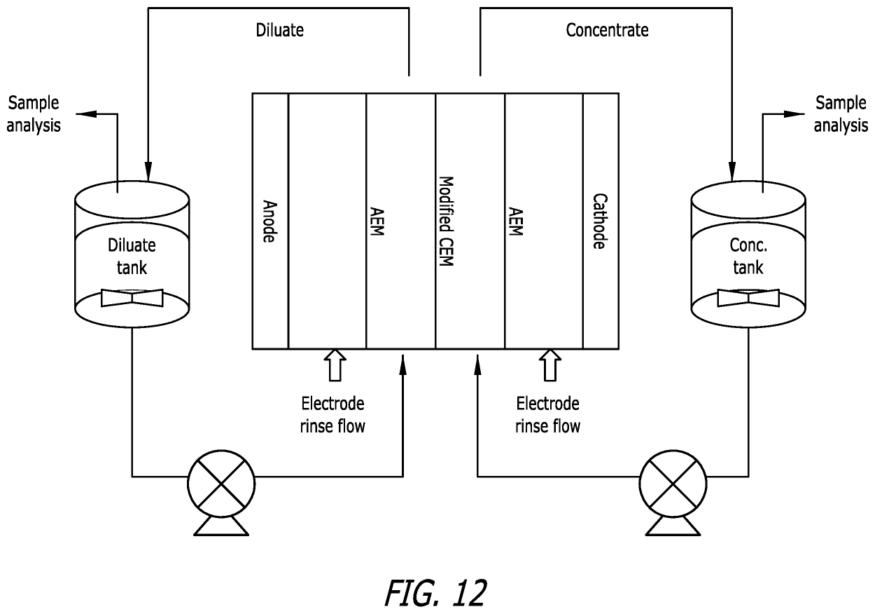

FIGS. 11A, 11B, and 11C respectively show schematic illustrations of electrodialysis processes, where FIG. 11A is a conventional cation-exchange membrane, FIG. 11B is a cation-exchange membrane with crown-ethers embedded in the cation-exchange membrane matrix, and FIG. 11C is a cation-exchange membrane with a surface overlayer of polymerized crown ethers creating an ion-gating functionality.

In some embodiments, the crown ethers form a continuous thin layer on the surface of the electrodialysis membrane to create an ion-gating mechanism. In such an embodiment, the continuous thin layer allows the sequestrants to serve as a molecular sieve to facilitate transport of target ions and impede the movement of background ions. In some embodiments, confining crown ethers in a thin over-layer also increases the local concentration of target ions. As a result, in such an embodiment, there can be an increase the number of activated neodymium (Nd³⁺) and dysprosium (Dy³⁺) species, which can produce steeper concentration gradient across the membrane. Further, in some embodiments, this can produce a steeper concentration gradient across the fluid boundary layer near the membrane surface, which is expected to lead to enhanced transport of the ions under an external electric field.

To functionalize conventional cation-exchange membranes (CEM), in some embodiments, polystyrene-supported ion sequestrants can be dissolved in dimethylformamide (DMF) or dichloromethane (DCM) at varying concentrations. In some embodiments, a piece of commercial cation-exchange membrane can be mounted onto a PTFE-coated HDPE platform. Further, in some embodiments, a stainless-steel low-pressure airbrush can be used to apply a thin layer of polystyrene-supported crown ethers to the membrane. In certain embodiments, the process can be followed by drying in air for several cycles until a desired crown ether loading is reached. In certain embodiments, the coating uniformity can be checked by adding a non-ionic dye to the polymer solution and inspecting the resultant membrane surface using an optical microscope.

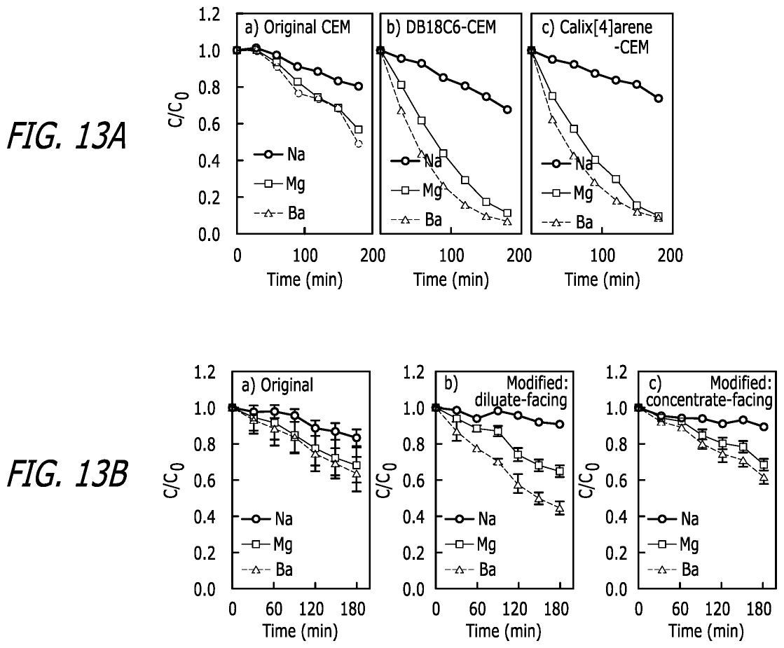

FIG. 12 depicts a schematic setup of an electrodialysis unit to evaluate the performance of chemically-enhanced cation-exchange membranes in accordance with certain embodiments of the present disclosure.

In some embodiments, the system includes a four-chamber electrodialysis unit with one electrodialysis cell pair. The system, in certain embodiments, can be used to observe the transport of target ions across the modified membranes and recover the target ions.

In some embodiments, two of the chambers of the electrodialysis unit allow recirculation of electrode rinse solutions. In such an embodiment, these two chambers can be the chambers close to the two end electrodes, where one is closest to the anode and the other is closest to the cathode.

In certain embodiments, the diluate and concentrate solutions flow through two middle chambers, which are separated by a piece of sequestrant-functionalized cation exchange membrane. In the embodiment depicted in FIG. 12, the effective membrane area of the unit is 64 cm². Further, in certain embodiments such as the exemplary embodiment of FIG. 12, the side of the membrane coated with supported crown ether can face the diluate chamber to serve as a selective ion-gate.

After the installation of a sequestrant-functionalized cation exchange membrane, each and all of the chambers can be flushed with sodium sulfate (Na2SO4) solutions to equilibrate the membrane with background electrolytes.

Subsequently, using the CEED system, a series of tests can be performed to assess the electrochemical properties of the membrane, including electrical resistance, ion transport number, and transport selectivity. The electrical resistance may be determined by varying the potential applied (V) and measuring the resulting current density, iD (mA/cm2). The slope of the initial linear portion of a V-iD plot can be used to calculate the electrical resistance of the entire stack.

By comparing the resistance of a stack equipped with an unmodified cation-exchange membrane against that of the modified cation-exchange membrane, the increase in resistance caused by the amendment of sequestrant polymers can be determined.

### Working Experiment

For the working experiment, the CEED system utilized commercially available cation-exchange membranes. In the working experiment, the membranes were stored in 1 M sodium chloride (NaCl) solution prior to use. All salts including nitrate salts of sodium, magnesium, and barium were of ACS reagent grade.

In the working example, tetrahydrofuran (THF) was dried over sodium and stored on activated molecular sieves prior to use. Anhydrous benzene and pyridine were purchased commercially (Sigma-Aldrich) and used as received. All other reagents were obtained from commercial vendors and used without any further purification. Synthesis routes to both the vinyl-substituted crown ethers and the “boot-strapped” calix[4]arene were conducted following FIGS. 4 and 5, respectively. Characterization of isolated organic products was accomplished using nuclear magnetic resonance (NMR) spectroscopy, and all data are fully consistent with the published spectral data.

Process for Synthesizing Ion Sequestrant 3,4-Dihydroxystyrene. In the embodiment of the working experiment, 3,4-dihydroxystyrene was synthesized. In particular, a mixture of methyl triphenylphosphonium bromide (20.15 mmol, 7.20 g, 1.5 equiv) in THF was treated with potassium tert-butoxide (33.57 mmol, 3.77 g, 2.5 equiv).

The process of the working experiment included stirring the mixture for 15 minutes at room temperature. After stirring for 15 minutes, in the working experiment, a solution of 3,4-dihydroxybenzaldehyde (13.39 mmol, 1.85 g, 1 equiv) in THF was added in a dropwise fashion to the reaction mixture. Following the process of the working experiment, after stirring overnight at room temperature, the reaction mixture was quenched with saturated ammonium chloride (NH4C1) solution and concentrated under reduced pressure.

Continuing the process of the working experiment, the concentrated reaction mixture was extracted with dichloromethane (DCM), and the organic layer was washed with brine and subsequently dried over a magnesium sulfate solution (MgSO4).

Next, as the process of the working experiment continued, the mixture was filtered, the organic solvent was removed via evaporation, and the residue was purified by column chromatography (15% ethyl acetate in hexanes) to obtain the pure product as a white solid (1.09 g, 60%).

Process for Synthesizing Crown Ethers: The process for the working experiment included adding DMF and potassium carbonate (2.18 equiv). The process continued with warming the mixture to approximately 150° C. Next, to the mixture was added both 3,4-dihydroxystyrene (1 equiv) and the desired dichloro-species (1 equiv) in a slow, dropwise manner. Following, in the working experiment, the reaction mixture was heated at 150° C. for a further 24 hours.

After completion of the reaction, the solvent was removed, and the crude product extracted with DCM. The organic phase was washed with saturated sodium bicarbonate (NaHCO₃), filtered, and the solvent was removed under reduced pressure to afford analytically pure crown ether products, namely, vinylbenzo-15-crown-5 (VB15C5), vinylbenzo-18-crown-6 (VB18C6), and vinylbenzo-21-crown-7 (VB21C7) (9, 10, or 11) as dark yellow and viscous oils (73, 85, and 81%, respectively).

Process for Synthesizing Calixarenes: In the working experiment, the process continued with the synthesis of p-tert-Butylcalix[4]arene (denoted as tBCalix4). The phenolic groups in tBCalix4 were functionalized to incorporate a crown ether “boot strap” and ionizable groups to form p-tert-butylcalix[4]arene-crown-6 and p-tert-butylcalix[4]arene-crown-6-dicarboxylic acid (tBCalix4-C6DA), respectively.

Process for Aqueous Extraction: In the working experiment, the process continued with an assessment of the synthesized crown ethers for their selectivity for barium and hardness ions via aqueous extraction experiments.

Process for Modification of Cation-Exchanging Membranes with Sequestrants: Following, in the working experiment, the surface of the membrane was deposited with a thin layer of the synthesized sequestrants to impart improved ion selectivity. Specifically, a membrane was removed from its storage solution, and excess water on the surface was wiped clean. The membrane was mounted on a glass platform with four corners of the membrane fixed using metal clamps. Next, in the working experiment, 120 mg of VB18C6 was dissolved in 20 mL of DCM (equivalent to 18 mM), and the solution was amended with methylene blue (to reach approximately 1 mM) to enable easy visualization of the coating uniformity.

Next, 2.5 mL of the crown ether solution was evenly sprayed on the exposed surface of a membrane using a hand-held precision air brush. In some embodiments, the air brush can be Aeroblend Light, and the even spray can be equivalent to a surface density of 0.70 μmol/cm2. Following, the process of the working experiment progressed with the membrane being allowed to air dry for 15 minutes to evaporate the solvent. Next, in the working experiment, the resultant membrane was rinsed with ethanol to remove excess DCM and was soaked in 1 M NaCl solution for 2 days with the soaking solution replaced periodically for at least three cycles.

In some embodiments, the modification of the cation-exchange membrane with calixarenes can follow. In such embodiments, the concentration of the respective sequestrant in DCM can be 12.5 mM, corresponding to a surface density of 0.49 μmol/cm2.

Process of Membrane Characterization: Following, the process of the working experiment continued with the native and modified cation-exchange membranes being characterized using Fourier transform infrared (FTIR) spectroscopy. In some embodiments, including that of the working experiment, the FTIR spectra can be recorded on a Nicolet iS10 infrared spectrometer.

Next, a small piece of the native or modified membrane was removed. To proceed with the process, the piece was placed in the center of the ATR, and a spectrum was collected. Accordingly, in the working experiment, the membrane potential was measured in barium solutions.

Electrodialysis Experiments: Electrodialysis tests were set up using the four-chamber electrodialysis unit of FIG. 12, which employed platinum/iridium-mixed metal oxide-coated titanium as the anode and stainless steel as the cathode. In some embodiments, the electrodialysis unit can be ED 64004 by PCCell GmbH, Germany.

In the working experiment, the cell dimension was 11 cm by 11 cm, and effective membrane area was 8 cm by 8 cm. In the working example, the two compartments in the center carried diluate and concentrate flows, respectively, which were separated by either a cation-exchange membrane or a chemically modified cation-exchange membrane. The chemically modified surface faced the diluate stream, in the working experiment, and the two compartments close to the electrode ends carried electrode rinse flows.

In the system of the working experiment, peristaltic pumps were used to recirculate the diluate, concentrate, and electrode rinse solutions between the electrodialysis unit and the respective tanks. In the embodiment of the working experiment, the electrode rinse solution was 0.2 M NaNO3 solution, the diluate and concentrate tanks had 0.5 L of Na⁺, Mg²⁺, and Ba²⁺ solution (as nitrate salts), and the concentration of each ion was initially the same in the two tanks to eliminate any initial concentration gradient.

In the process of the working experiment, prior to the start of a test, all chambers were flushed with the respective solutions for 30 minutes to equilibrate the membranes with solutions. Following that, a potential was applied to start the electrodialysis process. Periodically, a small aliquot of the sample, less than 1 mL, was drawn from the diluate and concentrate tanks. Samples were immediately diluted, filtered through 0.2 μM PTFE syringe filters, and acidified with nitric acid (HNO3) for storage at 4° C. prior to analysis for concentrations by inductively coupled plasma-mass spectrometry.

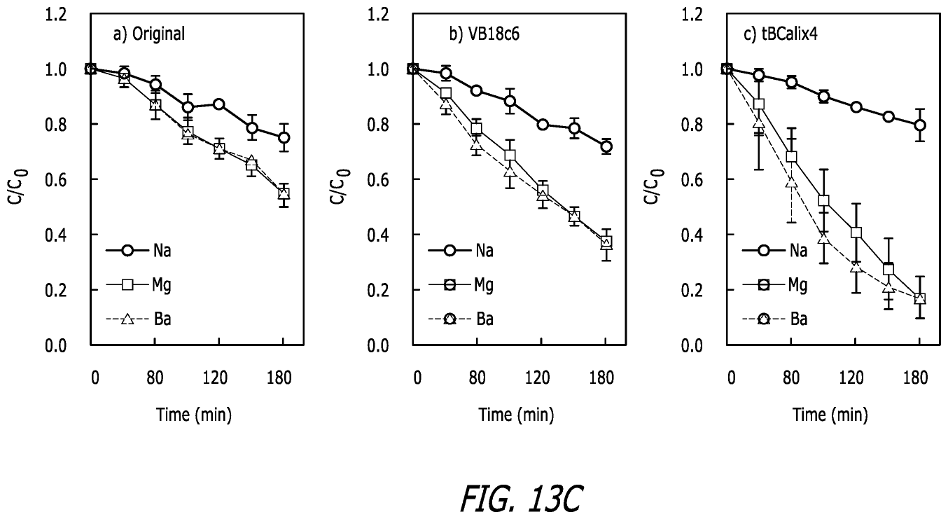

FIGS. 13A and 13B respectively depicts the results of the working example in respect to concentration data. Specifically, FIG. 13A depicts preliminary data showing the concentration profiles of Na, Mg, and Ba cations in the diluate tank of electrodialysis systems with (i) unmodified cation-exchange membrane, (ii) dibenzo-18-crown-6 loaded cation-exchange membrane, and (iii) calix[4]arene-loaded cation-exchange membrane. In the embodiment of the working experiment, the experiment conditions: Na=0.1 M, Mg=5×10-3 M, Ba=1×10-3 M, and current density=3.1 mA/cm2.

The concentration-normalized transport number of Ba relative to Na, Ba/Na is 4.6 and 5.5 for VB18c6 and calix[4]arene-loaded membranes, respectively, while that of the original cation-exchange membrane is 2.2.

Further, FIG. 13B depicts concentration profiles of Na, Mg, and Ba cations in the diluate tank of electrodialysis systems with (i) unmodified cation-exchange membrane, (ii) modified cation-exchange membrane with VB18C6 with the loaded surface facing the dilute stream, and (iii) modified cation-exchange membrane with VB18C6 with the loaded surface facing the concentrate stream. In the embodiment, the electrolytes in the feed water were 200 mM Na, 5 mM Mg, and 5 mM Ba, respectively. Further, in the embodiment, the current density was 3.1 mA/cm². Additionally, in the embodiment, the error bars represent one standard deviation.

The performance of the original and modified cation-exchange membranes was evaluated in the four-chamber electrodialysis unit of FIG. 12. FIG. 13B shows the normalized concentrations of ions in the diluate solution at various times. Using the original cation-exchange membrane, Mg²⁺ and Ba²⁻ were depleted more rapidly than Na⁺.

In comparison to the native cation-exchange membrane, the membrane modified with VB18C6, with the modified surface facing the diluate stream, afforded more rapid transport of Ba²⁺ and Mg²⁺, as shown by FIG. 13B. When the membrane was installed in the opposite orientation (i.e., the modified surface facing the concentrate), the enhanced selectivity was not observed.

Moreover, FIG. 13C depicts concentration profiles of Na, Mg, and Ba cations in the diluate stream of electrodialysis systems with (i) unmodified cation-exchange membrane, (ii) modified cation-exchange membrane with VB18C6, and (iii) modified cation-exchange membrane with tBCalix4. In the embodiment, the electrolytes in the feed water were 100 mM Na, 5 mM Mg, and 1 mM Ba, respectively. Further, in the embodiment, the current density was 3.1 mA/cm². Additionally, in the embodiment, the error bars represent one standard deviation.

As shown by FIG. 13C, in some embodiments, having a thin layer of crown ether or calixarene on the membrane surface rendered more efficient removal of Ba²⁺ and Mg²⁺ than the original membrane, with tBCalix4 showing stronger selectivity for the two ions than that with VB18C6. In the working example, and as shown by FIG. 13C, selectivity of barium over sodium was 6.88 with tBCalix4-amended cation-exchange membrane, while that of the crown ether-modified membrane and the unaltered membrane was 3.16 and 1.79, respectively. FIG. 13C additionally displays that the higher selectivity exhibited by the modified membranes arises from the enhanced transport of Ba²⁺ and Mg²⁺.

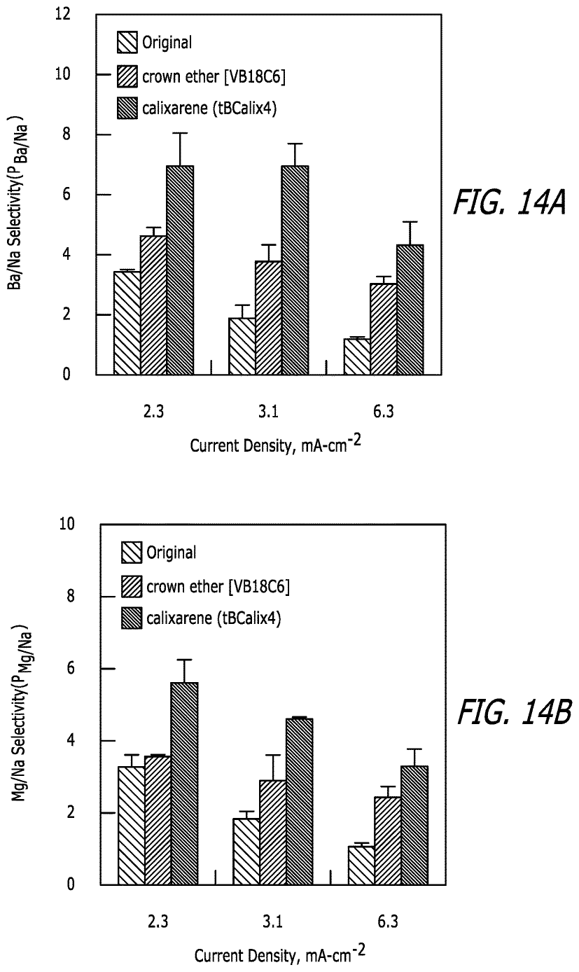

FIGS. 14A and 14B respectively depict the effect of current density on the selectivity of Ba²⁺ over Na⁺ and Mg²⁺ over Na⁺ during electrodialysis, respectively. In the embodiments of FIGS. 14A and 14B showing the results of the working experiment, the results show both the unmodified and crown ether or calixarene-modified cation-exchange membranes. In the embodiments, the electrolytes in the feed water were 100 mM Na, 5 mM Mg, and 1 mM Ba, respectively. Further, in the embodiments, the error bars represent one standard deviation.

For the unmodified membrane, the selectivity of Ba²⁺ and Mg²⁺ over Na⁺ decreased from 3.4 to 1.1 as the current density increased from 2.3 to 6.3 mA/cm², while the composition of the initial diluate and concentrate was held constant in all tests. As Ba²⁺ and Mg²⁺ were minority electrolytes, the current was largely carried by Na⁺ movement.

Amending the membrane with VB18C6 or tBCalix4 increased Ba²⁺ or Mg²⁺ selectivity over Na⁺ up to four times that of the unmodified cation-exchange membrane. The results of FIGS. 14A and 14B show that tBCalix4 rendered the membrane to be more selective than VB18C6. In some embodiments, the CEED system may utilize tBCalix4 for heightened selectivity.

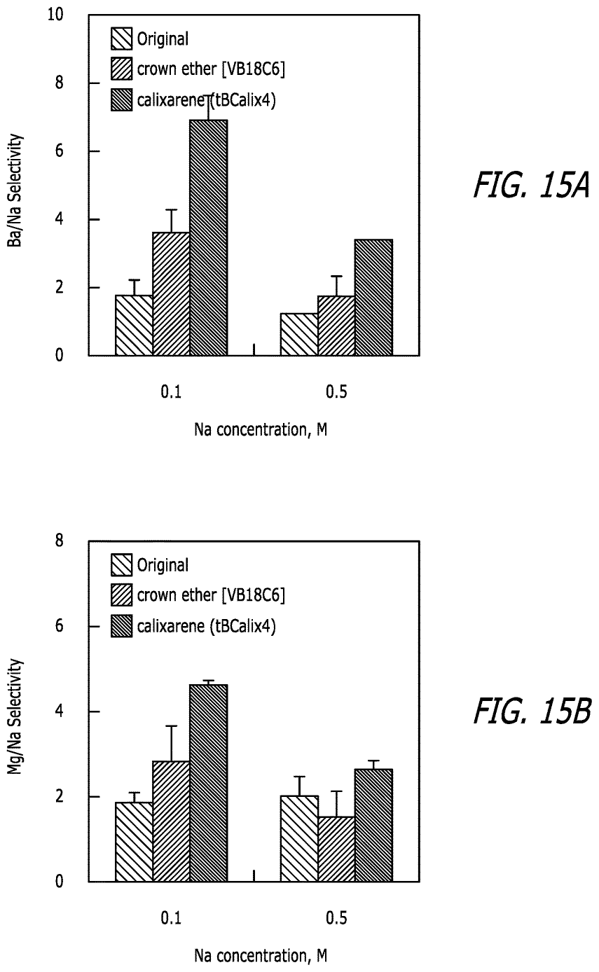

FIGS. 15A and 15B respectively depict the effect of sodium cation concentration as a result of the process in accordance with certain embodiments of the present disclosure. FIG. 15A displays the effect of sodium concentration on the selectivity of Ba²⁺ over Na⁺ during electrodialysis. FIG. 15B displays the effect of sodium concentration on the selectivity of Mg²⁺ over Na⁺ during electrodialysis. In the embodiments depicted in FIGS. 15A and 15B, the feed water contained 5 mM Mg and 1 mM Ba, in addition to Na⁺ ions. Further, in such an embodiment, the current density was 3.1 mA/cm². In the embodiment, the error bars represent one standard deviation.

To assess the effect of background electrolytes, the concentration of Na⁺ was adjusted between 0.1 and 0.5 M while keeping those of Mg²⁺ and Ba²⁺ constant. As shown in FIGS. 15A and 15B, the unmodified membrane exhibited minor variations in ion selectivity across the range of Na⁺ concentration evaluated. In contrast, as shown by FIGS. 15A and 15B, the selectivity of the modified membranes was very sensitive to the feedwater salinity. Overall, in such an embodiment, the effect of ion sequestrants was markedly attenuated as the feed water becomes increasingly saline.

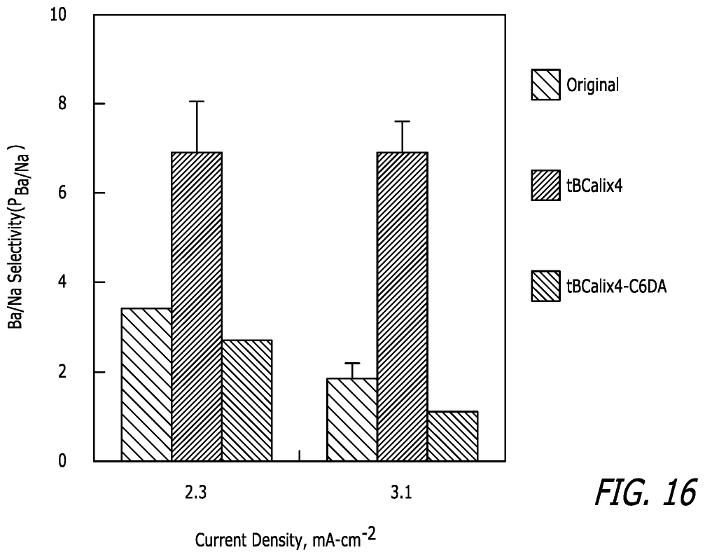

FIG. 16 depicts the results from the working experiment showing a comparison of ion selectivity of membranes deposited with tBCalix4 and tBCalix4-C6DA.

In the embodiment of FIG. 16, the electrolytes in the feed water were 100 mM Na, 5 mM Mg, and 1 mM Ba, respectively. Further, as shown in FIG. 16, the error bars represent one standard deviation.

The three-dimensional cone structure of calixarenes and their conformational flexibility give rise to their high chelating ability. As shown by FIG. 16, using the calixarene structure as a scaffold, an extensive family of calixarene-based ionophores was created. In some embodiments, as shown in FIG. 16, the p-tert-Butylcalix[4]arene-crown-6-dicarboxylic acid (i.e., tBCalix4-C6DA), can extract alkaline and alkaline-earth metals more efficiently than calix[4]arene.

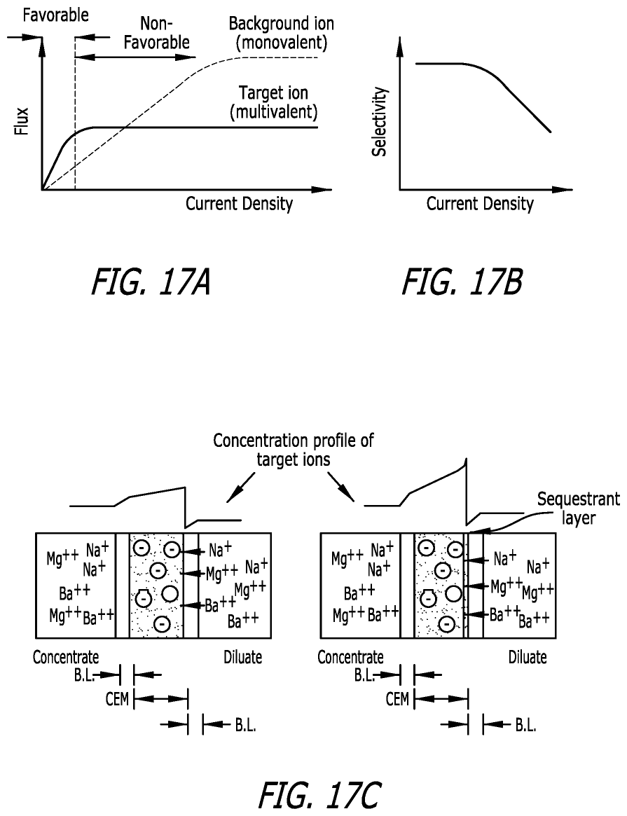

FIGS. 17A, 17B, and 17C respectively depict a conceptual model of increased barium and magnesium selectivity through surface modification with sequestrants. FIG. 17A displays the flux of ions in response to current density. FIG. 17B displays the selectivity of ions in response to current density. FIG. 17C displays the effect of membrane modification on the target ion concentration profile.

The results of the embodiment of FIGS. 17A, 17B, and 17C highlight that the ion that moves more efficiently across the membrane can depleted more severely in the boundary layer, thereby reducing its concentration near the entrance to the membrane. Accordingly, in some embodiments of the present disclosure, a thin layer of sequestrant molecules can be attached to the membrane surface, to increase the concentration of the target ion at the membrane-solution interface, giving rise to a greater concentration gradient across the membrane in the direction of ion flow. The effect is most evident at a medium-to-high current density or in a mild flow field when there is significant concentration depletion in the solution phase adjacent to the membrane.

The experimental result show that surface amendment of crown ether and calixarenes-based macrocycles (specifically, VB18C6 and calix[4]arene) increase the selectivity of the resultant CEMs for Ba²⁻ and Mg²⁺ relative to Na⁺, with calix[4]arene-modified membrane exhibiting greater selectivity improvements for the divalent ions than crown ether-amended counterparts. The optimal selectivity was achieved at a moderate-to-high current density (3.1 to 6.3 mA/cm²) at the given ion composition (mole ratio of Ba/Mg/Na=1/5/100).

As shown through the results, the CEED system can provide a customizable approach and can be extended to other ions of interest. In some embodiments, the optimal sequestrant does not necessarily need to be a strong chelating agent as the latter may form stable complexes that hamper ion movement as manifested in the case of tBCalix4-C6DA. In some embodiments, a continuous and non-porous layer that can effectively reduce the flux of the major ions may render the membrane to be more selective, although this may come at a cost of increased membrane electrical resistance and a lower current efficiency.

As a result, in certain embodiments, the CEED system is capable of reducing pollution and contamination from REEs that could negatively impact human health. Moreover, by allowing the extraction of increased REEs from nature and running water, the disclosed CEED system can enable increased opportunities to recycle REEs.

In some embodiments, following the extraction of REEs, the REEs themselves can be used in agriculture to increase plant growth, productivity, and stress resistance.

Further, in some embodiments, the CEED technology and system may be utilized to recover specific REEs. For example, in some embodiments, the extraction of REEs may result in obtaining certain REEs that are utilized in magnets, alloys, glasses, electronics, fuel cells, and nickel-metal hydride batteries. For example, the CEED system may recover cerium (Ce) and lanthanum (La), which are used as catalysts for petroleum refining and as diesel additives. As another example, the CEED system may recover neodymium (Nd), which is utilized in magnet production in traditional and low-carbon technologies. Moreover, in some embodiments, the CEED system may be utilized to recover REEs that can be used in the production and development of electric motors of hybrid and electric vehicles, generators in wind turbines, hard disc drives, portable electronics, microphones, speakers, LCD and plasma screens, fiber optics, and lasers, as well as in medical imaging.

Consistent with the above disclosure, the examples of systems and methods enumerated in the following clauses are specifically contemplated and are intended as a non-limiting set of examples.

Clause 1. A method for recovering target metal ions from a fluid stream using a chemically enhanced electrodialysis membrane, the method including selecting a cation-exchange membrane comprising a surface, where the cation-exchange membrane carries a fixed charge, permits the permeation of cations, and obstructs the passage of anions; synthesizing an ion sequestrant, where the ion sequestrant is capable of binding the target metal ions; grafting the ion sequestrant onto the cation-exchange membrane, where the grafting results in a thin layer of the ion sequestrant being affixed to the surface of the cation-exchange membrane, the thin layer of the ion sequestrant is continuous, and the thin layer being affixed to the surface creates an ion-gating mechanism; placing the cation-exchange membrane in an electrodialysis unit, where the electrodialysis unit comprises an anode, a cathode, and a diluate chamber; passing a diluate stream through the diluate chamber, where the diluate stream comprises the target metal ions; as a result of passing the diluate stream through the diluate chamber, passing the diluate stream through the thin layer of the ion sequestrant affixed to the surface of the cation-exchange membrane; and as a result of passing the diluate stream through the thin layer of the ion sequestrant, binding the target metal ions to the cathode-exchange membrane.

Clause 2. The method of any foregoing clause, where the ion sequestrant is selected from the group including crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

Clause 3. The method of any foregoing clause, where synthesis of ion sequestrant further comprises heating the ion sequestrant.

Clause 4. The method of any foregoing clause, where synthesis of ion sequestrant further comprises stirring the ion sequestrant.

Clause 5. The method of any foregoing clause, further including, prior to grafting the ion sequestrant onto the cation-exchange membrane, extracting an aqueous solution from the ion sequestrant.

Clause 6. The method of any foregoing clause, where the anode comprises platinum-iridium metal oxide.

Clause 7. The method of any foregoing clause, where the cathode comprises stainless steel.

Clause 8. The method of any foregoing clause, further including, after binding the target metal ions to the cathode-exchange membrane, removing the cathode-exchange membrane from the electrodialysis unit.

Clause 9. The method of any foregoing clause, further including recovering the target metal ions from the cathode-exchange membrane.

Clause 10. The method of any foregoing clause, where the target metal ions comprise a rare earth element.

Clause 11. The method of any foregoing clause, where the rare earth element comprises one or more of neodymium, dysprosium, cerium, lanthanum, or combinations thereof.

Clause 12. A system for using a chemically enhanced electrodialysis membrane, the system including an electrodialysis unit comprising an anode, a cathode, a diluate chamber, and a concentrate chamber, where the diluate chamber is configured to receive a diluate stream; a chemically modified cation-exchange membrane comprising a surface and a thin layer of an of an ion sequestrant affixed to the surface, where the chemically modified cation-exchange membrane carries a fixed charge, the chemically modified cation-exchange membrane permits the permeation of cations, the chemically modified cation-exchange membrane obstructs the passage of anions, and the ion sequestrant is configured to bind one or more target metal ions; and the diluate stream comprising the target metal ions, where the diluate stream is configured to flow in a direction approaching the diluate chamber and the thin layer on the surface of the chemically modified cation-exchange membrane.

Clause 13. The system of any foregoing clause, where the ion sequestrant is selected from the group including crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

Clause 14. The system of any foregoing clause, where the target metal ions comprise a rare earth element.

Clause 15. The system of any foregoing clause, where the rare earth element comprises one or more of neodymium, dysprosium, cerium, lanthanum, or combinations thereof.

Clause 16. The system of any foregoing clause, where the anode comprises platinum-iridium metal oxide.

Clause 17. A chemically enhanced electrodialysis membrane including a cation-exchange membrane comprising a surface, where the cation-exchange membrane carries a fixed charge, permits the permeation of cations, and obstructs the passage of anions; and a thin layer of an ion sequestrant affixed to the surface of the cation-exchange membrane, wherein the ion sequestrant is configured to bind one or more target metal ions.

Clause 18. The chemically enhanced electrodialysis membrane of any foregoing clause, where the ion sequestrant is selected from the group including crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

Clause 19. The chemically enhanced electrodialysis membrane of any foregoing clause, where the target metal ions comprise a rare earth element.

Clause 20. The chemically enhanced electrodialysis membrane of any foregoing clause, where the rare earth element comprises one or more of neodymium, dysprosium, cerium, lanthanum, or combinations thereof.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “~” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

### REFERENCES

1. Actinide Radionuclides with Crown Ethers. J. Radioanal. Chem. 1983 76, 49-62.
2. Afsar, A.; Laventine, D. M.; Harwood, L. M.; Hudson, M. J.; Geist, A. Utilizing electronic effects in the modulation of BTPhen ligands with respect to the partitioning of minor actinides from lanthanides. Chem. Commun. 2013, 49, 8534-8536.
3. Ahmadun, F. 1.-R.; Pendashteh, A.; Abdullah, L. C.; Biak, D. R. A.; Madaeni, S. S.; Abidin, Z. Z., Review of technologies for oil and gas produced water treatment. J. Hazard. Mater. 2009, 170, 530-551.
4 Alexandratos, S. D.; Stine, C. L., Synthesis of ion-selective polymer-supported crown ethers: a review. React. Funct. Polym. 2004, 60, 3-16.
5 Ansari, S. A.; Pathak, P.; Mohapatra, P. K.; Manchanda, V. K. Chemistry of Diglycolamides: Promising Extractants for Actinide Partitioning. Chem. Rev. 2012, 112, 1751-1772.
6 Arnaud-Neu, F.; Browne, J. K.; Byrne, D.; Marrs, D. J.; Mckervey, M. A.; O'Hagan, P.; Schwing-Weill, M. J.; Walker, A. Extraction and Complexation of Alkali, Alkaline Earth, and F-Element Cations by Calixaryl Phosphine Oxides. Chem. Eur. J. 1999, 5, 175-186.
7. Arnaud-Neu, F.; Schwing-Weill, M.-J.; Dozol, J.-F., Calixarenes for nuclear waste treatment. In Z. Asfari, V. Böhmer, J. Harrowfield, J. Vicens (Eds.), Calixarenes 2001, Kluwer Academic Publishers: Dordrecht, 2001, 642-662.
8. ASTM, ASTM Standard D 6908-03 Standard Practice for Integrity Testing of Water Filtration
9. Azakami, Yuka; Kappl, Michael; Fuiji, Syuji; Yusa, Shin-ichi; McNamee, Cathy E. Effect of the Addition of a Cross-Linker and the Water pH on the Physical Properties of Films of pH-Responsive Polymer Particles at Air/Water Interfaces. ACS Omega, 2017, 2, 7837-7848.
10. Bartsch, R. A. New Proton-Ionizable, Calixarene-Based Ligands for Selective Metal Ion Separations, Report Under Grant #DE-FG02-9414416, 2011.
11. Bhattacharyya, A.; Goswami, A. Effect of Cation Driven Loading of Dibenzo-18-Crown-6 in Nafion-117 Membrane on the Diffusion and Transport Behavior of Alkali Metal Ions. J. Phys. Chem. B 2009, 113, 12958-12963.
12. Bonvin, F.; Jost, L.; Randin, L.; Bonvin, E.; Kohn, T. Super-fine powdered activated carbon (SPAC) for efficient removal of micropollutants from wastewater treatment plant effluent. Water Res. 2016, 90, 90-99.
13. Buhlmann, P.; Pretsch, E.; Bakker, E., Carrier-based ion-selective electrodes and bulk optodes. 2. Ionophores for potentiometric and optical sensors. Chem. Rev. 1998, 98, 1593-1687.
14. Calderón, V.; Schwarz, G.; García, F.; Tapia, M. J.; Valente, A. J. M.; Burrows, H. D.; García, J. M., Synthesis and characterization of new aromatic polyamides bearing crown ethers and acyclic ethylene oxide units in the pendant structure. III. Benzo-18-crown-6 systems and their open-chain counterparts. J. Polym. Sci. Part A: Polym. Chem. 2006, 44, 6252-6269.
15. Casnati, A.; Barboso, S.; Rouquette, H.; Schwing-Weill, M.-J.; Arnaud-Neu, F.; Dozol, J.-F.; Ungaro, R. New Efficient Calixarene Amide Ionophores for the Selective Removal of Strontium Ion from Nuclear Waste: Synthesis, Complexation, and Extraction Properties. J. Am. Chem. Soc. 2001, 123, 12182-12190.
16. Cetin, M. M.; Hodson, R. Y.; Hart, C. R.; Cordes, D. B.; Findlater, M.; Casadonte, D. J.; Cozzolino, A. F.; Mayer, M. F. Synthesis, structural characterization, photophysical properties, theoretical calculations, and catalytic studies of 2,9-di(aryl)-12,10-phenanthroline copper (I) complexes. Dalton Trans. 2017, 6553-6569.
17. Chaudhury, S.; Bhattacharyya, A.; Goswami, A. Electrodriven Ion Transport through Crown Ether-Nafion Composite Membrane: Enhanced Selectivity of Cs+ over Na⁺ by Ion Gating at the Surface. Ind. Eng. Chem. Res. 2014, 53, 8804-8809.
18. Chen, X.; Ji, M.; Fisher, D. R.; Wai, C. M. Ionizable Calixarene-Crown Ethers with High Selectivity for Radium over Light Alkaline Earth Metal Ions. Inorg. Chem. 1999, 38, 5449-5452.
19. Dietz, M. L.; Chiarizia, R.; Horwitz, E. P.; Bartsch, R. A.; Talanov, V. Effect of crown ethers on the ion-exchange behavior of alkaline earth metals. Toward improved lon exchange methods for the separation and preconcentration of radium. Anal. Chem. 1997, 69, 3028-3037.
20. Drewes, J. E., An Integrated Framework for Treatment and Management of Produced Water. RPSEA Final Report for Contract 07122-12. National Energy Technology Lab (NETL), Department of Energy. 2011.
21. Ensor, D. D.; Reynolds, P. S., The Use of Crown Ethers as Synergistic Extraction Agents for Trivalent Lanthanides. J. Less-Common Met. 1989, 149, 287-290. (e) Maxwell, L.; Amoza, M.; Ruiz, E., Mononuclear Lanthanide Complexes with 18-Crown-6 Ether: Synthesis, Characterization, magnetic Properties, and Theoretical Studies. Inorg. Chem. 2018, 57, 13225-13234.
22. Env. Sci. Techn. 2015, 49, 9452.
23. Fréchet, J. M. J., Tetrahedron report number 103: Synthesis and applications of organic polymers as supports and protecting groups. Tetrahedron 1981, 37 (4), 663-683.
24. Furer, V. L.; Borisoglebskaya, E. I.; Zverev, V. V.; Kovalenko, V. I. The hydrogen bonding and conformations of p-tert-butylcalix[4]-arene as studied by IR spectroscopy and by DFT calculations. Spectrochim. Acta, Part A 2005, 62, 483-493.
25. Geise, G. M.; Falcon, L. P.; Freeman, B. D.; Paul, D. R. Sodium chloride sorption in sulfonated polymers for membrane applications. J. Membr. Sci. 2012, 423-424, 195-208.
26. Geise, G. M.; Freeman, B. D.; Paul, D. R. Sodium chloride diffusion in sulfonated polymers for membrane applications. J. Membr. Sci. 2013, 427, 186-196.
27. Georges, Michael K.; Veregin, Richard P. N.; Kazmaier, Peter M.; Hamer, Gordon K. Narrow
28. Glendening, E. D.; Feller, D., An ab initio investigation of the structure and alkaline earth divalent cation selectivity of 18-crown-6. J. Am. Chem. Soc. 1996, 118, 6052-6059.
29. Gohil, G. S.; Binsu, V. V.; Shahi, V. K. Preparation and characterization of monovalent ion selective polypyrrole composite ion-exchange membranes. J. Membr. Sci. 2006, 280, 210-218.
30. Gokel, G. W.; Leevy, W. M.; Weber, M. E., Crown ethers: Sensors for ions and molecular scaffolds for materials and biological models. Chem. Rev. 2004, 104, 2723-2750.
31. Goldstein, J.; Newbury, D. E.; Joy, D. C.; Lyman, C. E.; Echlin, P.; Lifshin, E.; Sawyer, L.; Michael, J. R., Scanning Electron Microscopy and X-ray Microanalysis. 3rd ed.; Springer: 2003.
32. Gregory, K. B.; Vidic, R. D.; Dzombak, D. A. Water Management Challenges Associated with the Production of Shale Gas by Hydraulic Fracturing. Elements 2011, 7, 181-186.
33. Guha, N. R.; Neyyappadath, R. M.; Greenhalgh, M. D.; Chisholm, R.; Smith, S. M.; McEvoy, M. L.; Young, C. M.; Rodríguez-Escrich, C.; Pericas, M. A.; Hahner, G.; Smith, A. D. Evaluating polymer-supported isothiourea catalysis in industrially-preferable solvents for the acylative kinetic resolution of secondary and tertiary heterocyclic alcohols in batch and flow. Green Chem. 2018, 20, 4537-4546.
34. Hancock, R. D.; Martell, A. E. Ligand design for selective complexation of metal ions in aqueous solution. Chem. Rev. 1989, 89, 1875-914.
35. He, C.; Li, M.; Liu, W.; Barbot, E.; Vidic, R. D. Kinetics and Equilibrium of Barium and Strontium Sulfate Formation in Marcellus Shale Flowback Water. J. Environ. Eng. 2014, 140, B4014001.
36. Helfferich, F. Ion Exchange; Dover Publications: New York, 1995.
37. Hermkens, P. H. H.; Ottenheijm, H. C. J.; Rees, D. Solid-phase organic reactions: A review of the recent literature. Tetrahedron 1996, 52, 4527-4554.
38. Hu, Y.; Wang, M.; Wang, D.; Gao, X.; Gao, C. Feasibility study on surface modification of cation exchange membranes by quaternized chitosan for improving its selectivity. J. Membr. Sci. 2008, 319, 5-9.
39. Hutchins, K. M.; Sekerak, N. M.; Moore, J. S. Polymerization Initiated by Particle Contact: A Quiescent State Trigger for Materials Synthesis. J. Am. Chem. Soc. 2016, 138, 12336-12339.
40. Innovation Metals Press Release, Feb. 18, 2016. IMC Announces Successful Testing of Proprietary Low-Cost Rapid Solvent Extraction Process.
41. Inoue, Y.; Ouchi, M.; Hakushi, T. Molecular design of crown ethers. 3. Extraction of alkaline-earth and heavy metal picrates with 14-crown-5 to 17-crown-5 and 17-crown-6 to 22-crown-6. Bull. Chem. Soc. Jpn. 1985, 58, 525-530.
42. Ion Exch. 2001, 19, 91-103.
43. Janarthanan, P.; Yunus, W.; Bin Ahmad, M., Thermal behavior and surface morphology studies on polystyrene grafted sago starch. J. Appl. Polym. Sci. 2003, 90, 2053-2058.
44. Jun, N.; Motoharu, T.; Hideo, T.; Eiji, U.; Yasuhiro, M.; Akira, O. Intramolecular [2+2] Photocycloaddition. 5. Synthetic Methods toward [2.n]-, [3.n]-, and [4.n]Naphthalenophane Skeletons by Using α,ω-Bis(vinylnaphthyl)alkanes. Bull. Chem. Soc. Jpn. 1989, 62, 3161-3166.
45. Kapolow, S.; Esch, T. E. H.; Smid, J., Poly(vinyl macrocyclic polyethers). Synthesis and Cation Binding Properties. Macromolecules 1973, 6, 133-142.
46. Khare, A. R.; Peppas, N. A. Swelling/deswelling of anionic copolymer gels. Biomaterials 1995, 16, 559-567.
47. Kido, Makoto; Nojima, Shiki; Ishige, Ryohei; White, Kevin L.; Kamitani, Kazutaka; Ohta,
48. Kim, D.; Powell, L. E.; Delmau, L. H.; Peterson, E. S.; Herchen-roeder, J.; Bhave, R. R.,
49. Kim, N. H.; Yoon, S.; Jung, K. I.; Lee, D. G.; Bang, J.; Jung, H. W. Crosslinking behaviors and mechanical properties of curable PDMS and PEG films with various contents of glycidyl methacrylate. J. Appl. Polym. Sci. 2018, DOI: 10.1002/APP.47088.
50. Kovalova, L.; Knappe, D. R. U.; Lehnberg, K.; Kazner, C.; Hollender, J. Removal of highly polar micropollutants from wastewater by powdered activated carbon. Environ. Sci. Pollut. Res. 2013, 20, 3607-3615.
51. Lewis, F. W.; Harwood, L. M.; Hudson, M. J.; Drew, M. G. B.; Desreux, J. F.; Vidick, G.; Bouslimani, N.; Modolo, G.; Wilden, A.; Sypula, M.; Vu, T.-H.; Simonin, J.-P. Highly Efficient Separation of Actinides from Lanthanides by a Phenathroline-Derived Bis-triazine Ligand. J. Am. Chem. Soc. 2011, 133, 13093-13102.
52. Ling, Y.; Klemes, M. J.; Xiao, L.; Alsbaiee, A.; Dichtel, W. R.; Helbling, D. E. Benchmarking Micropollutant Removal by Activated Carbon and Porous β-Cyclodextrin Polymers under Environmentally Relevant Scenarios. Environ. Sci. Technol. 2017, 51, 7590-7598.
53. Liu, F. Q.; Yi, B. L.; Xing, D. M.; Yu, J. R.; Zhang, H. M., Nafion/PTFE composite membranes for fuel cell applications. J. Membr. Sci. 2003, 212, 213-223.
54. Liu, Xiang; Henderson, James A.; Sasaki, Takeo; Kishi, Yoshito. Dramatic Improvement in Catalyst Loadings and Molar Ratios of Coupling Partners for Ni/Cr-Mediated Coupling Reactions: Heterobimetallic Catalysts. J. Am. Chem. Soc. 2009, 131, 16678-16680.
55. Liu, Y.; Han, B.-H.; Li, Y.-M.; Chen, R.-T.; Ouchi, M.; Inoue, Y., Molecular Design of Crown Ethers. 13. Complexation Thermodynamics of Light Lanthanoid Nitrates with Aza-16-Crown-5 Lariat in Acetonitrile: Enhanced Selectivity for Nd3+. J. Phys. Chem. 1996, 100, 17361-17364.
56. Loya, J. D.; Qiu, J.; Unruh, D. K.; Cozzolino, A. F.; Hutchins, K. M. Cocrystallization of the Anti-Cholesterol Drug Bezafibrate: Molecular Recognition of a Pharmaceutical Contaminant in the Solid State and Solution via Hydrogen Bonding. Cryst. Growth Des. 2018, 18, 4838-4843.
57. Lukashevaa, Natalia, V.; Tolmacheva, Dmitry A.; Karttunen, Mikko. Mineralization of phosphorylated cellulose: Crucial role of surface structure and monovalent ions for optimizing calcium content. Phys. Chem. Chem. Phys. 2018, DOI: 10.1039/C8CP05767B.
58. Luo, T.; Abdu, S.; Wessling, M. Selectivity of ion exchange membranes: A review. J. Membr. Sci. 2018, 555, 429-454.
59. Maity, H. S.; Misra, K.; Mahata, T.; Nag, A., CSJ Acting as a Versatile Highly Efficient Greener Resource for Organic Transformations. RSC Advances, 2016, 24446-24450.
60. McGovern, R. K.; Weiner, A. M.; Sun, L.; Chambers, C. G.; Zubair, S. M.; Lienhard V, J. H. On the cost of electrodialysis for the desalination of high salinity feeds. Appl. Energy 2014, 136, 649-661.
61. McNamara, C. A.; Dixon, M. J.; Bradley, M. Recoverable Catalysts and Reagents Using Recyclable Polystyrene-Based Supports. Chem. Rev. 2002, 102, 3275-3300.
62. Membrane Systems. ASTM International West Conshohocken PA, USA . . .
63. Merrill, D.; Hancock, R. D. Radiochim. Acta, 2011, 99, 161.
64. Merrill, D.; Harrington, J. M.; Lee, H.-S.; Hancock, R. D. Inorg. Chem. 2011, 50, 8348.
65. Molecular Weight Resins by a Free-Radical Polymerization Process. Macromolecules 1993, 26, 2987-2988.
66. Naganawa, H.; Sugo, Y.; Shimojo, K.; Mitamura, H. Diglycolamide-type agent and method for extraction of rare earth metals. JP2007327085A, 2007.
67. Nagarale, R. K.; Gohil, G. S.; Shahi, V. K. Recent developments on ion-exchange membranes and electro-membrane processes. Adv. Colloid Interface Sci. 2006, 119, 97-130.
68. Narita, H.; Tanaka, M. Separation of rare earth elements from base metals in concentrated nitric acid, sulfuric acid and hydrochloric acid solutions with diglycolamide. Solvent Extr. Res. Dev., Jpn. 2013, 20, 115-121.
69. National Research Council. Desalination: A National Perspective; Washington, D.C., 2008.
70. Nie, Hai-Jing; Yao, Jiannian; Zhong, Yu-Wu. Synthesis of Vinyl-Substituted Polypyridyl Ligands through Suzuki-Miyaura Cross-Coupling of Potassium Vinyltrifluoroborate with Bromopolypyridines. J. Org. Chem. 2011, 76, 4771-4775.
71. Noboru; Hirai, Tomoyasu; Takahara, Atsushi. Effect of Molecular Weight on Microcrystalline Structure Formation in Polymer with Perylenediimide Side Chain. J. Polym. Sci., Part B: Polym. Phys. 2016, 54, 2275-2283.
72. Ohto, K.; Matsufuji, T.; Yoneyama, T.; Tanaka, M.; Kawakita, H.; Oshima, T., Preorganized, cone-conformational calix[4]arene possessing four propylenephosphonic acids with high extraction ability and separation efficiency for trivalent rare earth elements. J. Inclusion Phenom. Macrocyclic Chem. 2011, 71, 489-497.
73. Osaka, Itaru; Saito, Masahiko; Mori, Hiroki; Koganezawa, Tomoyuki; Takimiya, Kazuo. Drastic Change of Molecular Orientation in a Thiazolothiazole Copolymer by Molecular-Weight Control and Blending with PC61BM Leads to High Efficiencies in Solar Cells. Adv. Mater. 2012, 24, 425-430.
74. Park, C.; Chun, S.; Bartsch, R. A. Effect of conformation on metal ion extraction by calix[4]arene dicarboxylic acids. J. Inclusion Phenom. Macrocyclic Chem. 2010, 66, 95-105.
75. PCA GmbH, PCA ion exchange membranes: Technical data sheet. October 2013.
76. Pedersen, C. J., Cyclic polyethers and their complexes with metal salts. J. Am. Chem. Soc. 1967, 89, 7017-7036.
77. Perera, S.; Findlater, M. Dimerization of Vinyl Silanes by the Putative [(Phenanthroline) PdMe] Cation to 1,4-Bis(trialkoxysilyl) butenes. Inorganics 2018, 6, 102.
78. Perkin Elmer Instruments, Analytical Methods for Atomic Absorption Spectrometry Rev. E. Perkin Elmer Instrument LLC: 2000.
79. Perkin Elmer Instruments, Atomic Spectrocopy, A Guide to Selecting the Appropriate Technique and System, Perkin Elmer Instrument LLC: 2011.
80. Pigaleva, Marina A.; Portnov, Ivan V.; Rudov, Andrey A.; Blagodatskikh, Inesa V.; Grigoriev, Timofei E.; Gallyamov, Marat O.; Potemkin, Igor I. Stabilization of Chitosan Aggregates at the Nanoscale in Solutions in Carbonic Acid. Macromolecules 2014, 47, 5749-5758.
81. Prabhakaran, V.; Arges, C. G.; Ramani, V., Investigation of polymer electrolyte membrane chemical degradation and degradation mitigation using in situ fluorescence spectroscopy. Proc. Natl. Acad. Sci. U.S.A 2012, 109, 1029-1034.
82. Rusanova, J. A.; Domasevitch, K. V.; Vassilyeva, O. Y.; Kokozay, V. N.; Rusanov, E. B.; Nedelko, S. G.; Chukova, O. V.; Ahrens, B.; Raithby, P. R., New luminescent copper (I) halide complexes containing Rb+ complexes of 18-crown-6 as counter ions prepared from zerovalent copper. J. Chem. Soc., Dalton Trans. 2000, (13), 2175-2182.
83. Sachleben, R. A.; Davis, M. C.; Bruce, J. J.; Ripple, E. S.; Driver, J. L.; Moyer, B. A. An efficient synthesis of lithium-selective extractants: Tertiary-alkyl-14-crown-4 ethers. Tetrahedron Lett. 1993, 34, 5373-5376.
84. Sakamoto, H.; Kimura, K.; Shono, T. Proton-driven cation transport through polyamic acid membranes incorporating crown ether moiety. Eur. Polym. J. 1986, 22, 97-101.
85. Saracco, G. Transport properties of monovalent-ion-permselective membranes. Chem. Eng. Sci. 1997, 52, 3019-3031.
86. Sasaki, Y.; Sugo, Y.; Suzuki, S.; Tachimori, S. The novel extractants, diglycolamides, for the extraction of lanthanides and actinides in nitric acid n-dodecane system. Solvent Extr.
87. Sata, T. Ion Exchange Membranes: Preparation, Characterization, Modification and Application; The Royan Society of Chemistry: Cambridge, UK, 2004.
88. Sata, T.; Sata, T.; Yang, W. Studies on cation-exchange membranes having permselectivity between cations in electrodialysis. J. Membr. Sci. 2002, 206, 31-60.
89. Sata, T.; Yoshida, T.; Matsusaki, K. Transport properties of phosphonic acid and sulfonic acid cation exchange membranes. J. Membr. Sci. 1996, 120, 101-110.
90. Shaffer, D. L.; Arias Chavez, L. H.; Ben-Sasson, M.; Romero-Vargas Castrillón, S.; Yip, N. Y.; Elimelech, M. Desalination and Reuse of High-Salinity Shale Gas Produced Water: Drivers, Technologies, and Future Directions. Environ. Sci. Technol. 2013, 47, 9569-9583.
91. Shimojo, K.; Kurahashi, K.; Naganawa, H., Dalton Trans. 2008, 5083.
92. Shimojo, K.; Naganawa, H.; Noro, J.; Kubota, F.; Goto, M. Anal. Sci. 2007, 23, 1427.
93. Sholl, D. S.; Lively, R. P. Seven chemical separations to change the world. Nature 2016, 532 (7600), 435-437.
94. Smith Stegen, K. Heavy rare earths, permanent magnets, and renewable energies: An imminent crisis. Energy Policy 2015, 79, 1-8.
95. Smitha, B.; Sridhar, S.; Khan, A. A., Synthesis and characterization of proton conducting polymer membranes for fuel cells. J. Membr. Sci. 2003, 225, 63-76.
96. Staudt-Bickel, Claudia; Korosb, William J. Improvement of CO2/CH4 separation characteristics of polyimides by chemical crosslinking. J. Membr. Sci. 1999, 155, 145-154.
97. Stevens, P. D.; Fan, J.; Gardimalla, H. M. R.; Yen, M.; Gao, Y. Superparamagnetic Nanoparticle—
98. Strathmann, H. Ion-exchange Membrane Separation Processes; Elsevier: Amsterdam, 2004.
99. Strzelbicki, J.; Bartsch, R. A., Extraction of alkali-metal cations from aqueous solutions by a crown-ether carboxylic acid. Anal. Chem. 1981, 53, 1894-1899.
100. Supported Catalysis of Suzuki Cross-Coupling Reactions. Org. Lett. 2005, 7, 2085-2088.
101. Sutherland, I. O. Ion recognition by macrocyclic hosts. J. Chem. Soc., Faraday Trans. 1 1986, 82, 1145-59.
102. Tan, S.; Tieu, J. H.; Bélanger, D. Chemical Polymerization of Aniline on a Poly(styrene sulfonic acid) Membrane: Controlling the Polymerization Site Using Different Oxidants. J. Phys. Chem. B 2005, 109, 14085-14092.
103. Tang, J.; Wai, C. M., Solvent Extraction of Lanthanides with a Crown Ether Carboxylic Acid. Anal. Chem. 1986, 58, 3233-3235.
104. Thunhorst, K. L.; Noble, R. D.; Bowman, C. N., Properties of the transport of alkali metal salts through polymeric membranes containing benzo-18-crown-6 crown ether functional groups. J. Membr. Sci. 1999, 156, 293-302.
105. Tsukube, H.; Hamada, T.; Tanaka, T.; Uenishi, J. i. Specific recognition of copper ion by lipid-bound double armed crown ether. Inorg. Chim. Acta 1993, 214, 1-3.
106. Tunca, U.; Yagci, Y., Crown ether-containing polymers. Prog. Polym. Sci. 1994, 19, 233-286.
107. Turek, M.; Was, J.; Dydo, P. Brackish water desalination in ROsingle pass EDR system. Desalin. Water Treat. 2009, 7, 263-266.
108. Uliana, A. A.; Bui, N. T.; Kamcev, J.; Taylor, M. K.; Urban, J. J.; Long, J. R. Ion-capture electrodialysis using multifunctional adsorptive membranes. Science 2021, 372, 296.
109. US Department of Energy. The Water-Energy Nexus: Challenges and Opportunities, 2014.
110. Ustynyuk, Yu. A.; Borisova, N. E.; Babain, V. A.; Gloriozov, I. P.; Manuilov, A. Y.; Kalmykov, S. N.; Alyapyshev, M. Yu.; Tkachenko, L. I.; Kenf, E. V.; Ustynyuk, N. A., N,N′-Dialkyl-N,N′-diaryl-1,10-phenanthroline-2,9-dicarboxamides as donor ligands for separation of rare earth elements with a high and unusual selectivity. DFT computational and experimental studies. Chem. Commun. 2015, 7466-7469.
111. Vaino, A. R.; Goodin, D. B.; Janda, K. D. Investigating Resins for Solid Phase Organic Synthesis: The Relationship between Swelling and Microenvironment As Probed by EPR and Fluorescence Spectroscopy. J. Comb. Chem. 2000, 2, 330-336.
112. Vallois, C.; Sistat, P.; Roualdès, S.; Pourcelly, G. Separation of H+/Cu2+ cations by electrodialysis using modified proton conducting membranes. J. Membr. Sci. 2003, 216, 13-25.
113. Veerman, J.; Post, J. W.; Saakes, M.; Metz, S. J.; Harmsen, G. J., Reducing power losses caused by ionic shortcut currents in reverse electrodialysis stacks by a validated model. J. Membr. Sci. 2008, 310, 418-430.
114. Wang, Q.; Gu, K.-H.; Zhang, Z.; Hou, P.; Shen, Z.; Fan, X.-H. Morphologies and photonic properties of an asymmetric brush block copolymer with polystyrene and polydimethylsiloxane side chains. Polymer 2018, 156, 169-178.
115. Wenji, W.; Bozhong, C.; Zhong-Kao, J. Ailing, W., Extraction of Several Lanthanide and
116. White, N.; Misovich, M.; Yaroshchuk, A.; Bruening, M. L. Coating of Nafion Membranes with Polyelectrolyte Multilayers to Achieve High Monovalent/Divalent Cation Electrodialysis Selectivities. ACS Appl. Mater. Interfaces 2015, 7, 6620-6628.
117. Wijmans, J. G.; Baker, R. W. The solution-diffusion model: a review. J. Membr. Sci. 1995, 107, 1-21.
118. Wilson, A. M.; Bailey, P. J.; Tasker, P. A.; Turkington, J. R.; Grant, R. A.; Love, J. B. Solvent extraction: the coordination chemistry behind extractive metallurgy. Chem. Soc. Rev. 2014, 43, 123-134.
119. Xie, F.; Zhang, T. A.; Dreisinger, D.; Doyle, F. A critical review on solvent extraction of rare earths from aqueous solutions. Miner. Eng. 2014, 56, 10-28.
120. Xu, P.; Capito, M.; Cath, T. Y. Selective removal of arsenic and monovalent ions from brackish water reverse osmosis concentrate. J. Hazard. Mater. 2013, 260, 885-891.
121. Xu, X.; Asher, S. A. Synthesis and Utilization of Monodisperse Hollow Polymeric Particles in Photonic Crystals. J. Am. Chem. Soc. 2004, 126, 7940-7945.
122. Yang, L.; Tang, C.; Ahmad, M.; Yaroshchuk, A.; Bruening, M. L. High Selectivities among Monovalent Cations in Dialysis through Cation-Exchange Membranes Coated with Polyelectrolyte Multilayers. ACS Appl. Mater. Interfaces 2018, 10, 44134-44143.
123. Yang, Y.; Liu, J.; Li, K.; Zhang, H.; Luo, S.; Rao, L. Probing the differences in covalence by enthalpy measurements: a new heterocylic N-donor ligand for actinide/lanthanide separation. Dalton Trans. 2015, 44, 8959-8970.
124. Yeung, Y. Y.; Tanner, P. A.; Trends in Atomic Parameters for Crystals and Free Ions across the Lanthanide Series: The Case of LaCl3: Ln3+. J. Phys. Chem. A 2015, 119, 6309-6316.
125. Zhang, T.; Gregory, K.; Hammack, R. W.; Vidic, R. D. Coprecipitation of Radium with Barium and Strontium Sulfate and Its Impact on the Fate of Radium during Treatment of Produced Water from Unconventional Gas Extraction. Environ. Sci. Technol. 2014, 48, 4596-4603.
126. Zheng, Q.; Rood, S. L; Unruh, D. K.; Hutchins, K. M. Cocrystallization of anti-inflammatory pharmaceutical contaminants and rare carboxylic acidpyridine supramolecular synthon breakdown. CrystEngComm 2018, 20, 6377-6381.
127. Zhou, H.; Surowiec, K.; Purkiss, D. W.; Bartsch, R. A. Proton di-ionizable p-tertbutylcalix[4]arene-crown-6 compounds in cone, partial-cone and 1,3-alternate conformations: synthesis and alkaline earth metal cation extraction. Org. Biomol. Chem. 2005, 1676-1684.
128. Ziemkiewicz, P.; Hause, J.; Lovett, R.; Locke, D.; Johnson, H.; Patchen, D. Zero Discharge Water Management for Horizontal Shale Gas Well Development. Final Report for DOE Award No. DEFE0001466, 2012.

1. A method for recovering target metal ions from a fluid stream using a chemically enhanced electrodialysis membrane, the method comprising:
(a) selecting a cation-exchange membrane comprising a surface, wherein the cation-exchange membrane:
(i) carries a fixed charge,
(ii) permits the permeation of cations, and
(iii) obstructs the passage of anions;
(b) synthesizing an ion sequestrant, wherein the ion sequestrant is capable of binding the target metal ions;
(c) grafting the ion sequestrant onto the cation-exchange membrane, wherein:
(i) the grafting results in a thin layer of the ion sequestrant being affixed to the surface of the cation-exchange membrane,
(ii) the thin layer of the ion sequestrant is continuous, and
(iii) the thin layer being affixed to the surface creates an ion-gating mechanism;
(d) placing the cation-exchange membrane in an electrodialysis unit, wherein the electrodialysis unit comprises an anode, a cathode, and a diluate chamber;
(e) passing a diluate stream through the diluate chamber, wherein the diluate stream comprises the target metal ions;
(f) as a result of passing the diluate stream through the diluate chamber, passing the diluate stream through the thin layer of the ion sequestrant affixed to the surface of the cation-exchange membrane; and
(g) as a result of passing the diluate stream through the thin layer of the ion sequestrant, binding the target metal ions to the cathode-exchange membrane.

2. The method of claim 1, wherein the ion sequestrant is selected from the group consisting of crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

3. The method of claim 1, wherein synthesis of ion sequestrant further comprises heating the ion sequestrant.

4. The method of claim 1, wherein synthesis of ion sequestrant further comprises stirring the ion sequestrant.

5. The method of claim 1, further comprising, prior to grafting the ion sequestrant onto the cation-exchange membrane, extracting an aqueous solution from the ion sequestrant.

6. The method of claim 1, wherein the anode comprises platinum-iridium metal oxide.

7. The method of claim 1, wherein the cathode comprises stainless steel.

8. The method of claim 1 further comprising, after binding the target metal ions to the cathode-exchange membrane, removing the cathode-exchange membrane from the electrodialysis unit.

9. The method of claim 8 further comprising recovering the target metal ions from the cathode-exchange membrane.

10. The method of claim 1, wherein the target metal ions comprise a rare earth element.

11. The method of claim 10, wherein the rare earth element comprises one or more of neodymium, dysprosium, cerium, lanthanum, or combinations thereof.

12. A system for using a chemically enhanced electrodialysis membrane, the system comprising:
(a) an electrodialysis unit comprising an anode, a cathode, a diluate chamber, and a concentrate chamber, wherein the diluate chamber is configured to receive a diluate stream;
(b) a chemically modified cation-exchange membrane comprising a surface and a thin layer of an of an ion sequestrant affixed to the surface, wherein:
(i) the chemically modified cation-exchange membrane carries a fixed charge,
(ii) the chemically modified cation-exchange membrane permits the permeation of cations,
(iii) the chemically modified cation-exchange membrane obstructs the passage of anions, and
(iv) the ion sequestrant is configured to bind one or more target metal ions; and
(c) the diluate stream comprising the target metal ions, wherein the diluate stream is configured to flow in a direction approaching the diluate chamber and the thin layer on the surface of the chemically modified cation-exchange membrane.

13. The system of claim 12, wherein the ion sequestrant is selected from the group consisting of crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

14. The system of claim 12, wherein the target metal ions comprise a rare earth element.

15. The system of claim 14, wherein the rare earth element comprises one or more of neodymium, dysprosium, cerium, lanthanum, or combinations thereof.

16. The system of claim 12, wherein the anode comprises platinum-iridium metal oxide.

17. A chemically enhanced electrodialysis membrane comprising:
(a) a cation-exchange membrane comprising a surface, wherein the cation-exchange membrane:
(i) carries a fixed charge,
(ii) permits the permeation of cations, and
(iii) obstructs the passage of anions; and
(b) a thin layer of an ion sequestrant affixed to the surface of the cation-exchange membrane, wherein the ion sequestrant is configured to bind one or more target metal ions.

18. The chemically enhanced electrodialysis membrane of claim 17, wherein the ion sequestrant is selected from the group consisting of crown ether, calixarene, styryl-modified crown ether, t-Butyl calix[4]arene, phenanthroline, crown-ether ‘bootstrapped’ t-Butylcalix[4]arene, ionizable crown-ether ‘boot-strapped’ t-Butylcalix[4]arene, or combinations thereof.

19. The chemically enhanced electrodialysis membrane of claim 17, wherein the target metal ions comprise a rare earth element.

20. The chemically enhanced electrodialysis membrane of claim 19, wherein the rare earth element comprises one or more of neodymium, dysprosium, cerium, lanthanum, or combinations thereof.
